(19) United States
(12) Patent Application Publication
(10) Pub. No.: US 2015/0077720 A1
(43) Pub. Date: Mar. 19, 2015

(54) PROJECTION DEVICE, IMAGE CORRECTION METHOD, AND COMPUTER-READABLE RECORDING MEDIUM

(71) Applicant: JVC KENWOOD CORPORATION, YOKOHAMA-SHI (JP)

(72) Inventors: Hironobu FUKUTOMI, Yokosuka-shi (JP); Katsumi WATANUKI, Machida-shi (JP); Shunichi SHICHIJO, Yokosuka-shi (JP)

(21) Appl. No.: 14/549,343

(22) Filed: Nov. 20, 2014

Related U.S. Application Data
(63) Continuation of application No. PCT/JP2013/063463, filed on May 14, 2013.

(30) Foreign Application Priority Data
May 22, 2012 (JP) 2012-117016

(51) Int. Cl. H04N 9/31; G03B 21/14

(52) U.S. Cl. CPC H04N 9/3185; G03B 21/145
USPC 353/70; 353/121

(57) ABSTRACT

A projection device converts input image data into light and includes a correction control unit that calculates a correction amount used for eliminating a geometric distortion occurring in a projection image according to a projection direction based on a projection angle and a view angle and determines a cut out range including also an area other than an area of the image data after the geometric distortion correction estimated according to the correction amount, and a correction unit that generates cut out image data acquired by cutting out an area of the cut out range from the input image data and performs a geometric distortion correction for the cut out image data based on the correction amount.

### CROSS-REFERENCE TO RELATED APPLICATION(S)

This application is a continuation of International Application No. PCT/JP2013/063463, filed on May 14, 2013 which claims the benefit of priority of the prior Japanese Patent Application No. 2012-117016, filed on May 22, 2012, the entire contents of which are incorporated herein by reference.

### BACKGROUND OF THE INVENTION

1. Field of the Invention

The present invention relates to a projection device, an image correction method, and a computer-readable recording medium.

2. Description of the Related Art

A projection device such as a projector device is known which drives display elements based on an input image signal and projects an image relating to the image signal on a projection face of a projection medium such as a screen or a wall face. In such a projection device, in a case where a projection image is projected not in a state in which an optical axis of a projection lens is perpendicular to the projection face but in a state in which the optical axis of the projection lens is inclined with respect to the projection face, a problem of a so-called trapezoidal distortion in which a projection image originally projected in an approximate rectangular shape is displayed to be distorted in a trapezoidal shape on the projection face occurs.

Accordingly, conventionally, by performing a trapezoidal distortion correction (keystone correction) for converting an image that is a projection target into a trapezoidal shape formed in a direction opposite to that of the trapezoidal distortion formed in the projection image displayed on the projection face, a projection image having an approximately rectangular shape without any distortion is displayed on the projection face.

For example, in Japanese Patent Application Laid-open No. 2004-77545, a technology for projecting an excellent video for which a trapezoidal distortion correction has been appropriately performed onto a projection face in a projector in a case where the projection face is either a wall face or a ceiling is disclosed.

In such a conventional technology, when a trapezoidal distortion correction (keystone correction) is performed, an image is converted into a trapezoidal shape formed in a direction opposite to a trapezoidal distortion generated in a projection image according to a projection direction, and the converted image is input to a display device, whereby the keystone correction is performed. Accordingly, on the display device, an image having the number of pixels that is smaller than the number of pixels that can be originally displayed by the display device is input in the trapezoidal shape formed in the opposite direction, and a projection image is displayed in an approximately rectangular shape on the projection face onto which the projection image is projected.

In the conventional technology as described above, in order not to display an area of the periphery of the projection image onto which the approximately rectangular-shaped original projection image is projected, in other words, a differential area between the area of the projection image of a case where no correction is made and the area of the projection image after the correction on the projection face, image data corresponding to black is input to the display device, or the display device is controlled not to be driven. Accordingly, there are problems in that the pixel area of the display device is not effectively used, and the brightness of the actual projection area decreases.

Meanwhile, recently, in accordance with wide use of high-resolution digital cameras, the resolution of a video content is improved, and thus, there are cases where the resolution of the video content is higher than the resolution of a display device. For example, in a projection device such as a projector that supports up to full HD of 1920 pixels×1080 pixels as an input image for a display device having resolution of 1280 pixels×720 pixels, the input image is scaled in a prior stage of the display device so as to match the resolution such that the whole input image can be displayed on the display device, or a partial area of the input image that corresponds to the resolution of the display device is cut out and is displayed on the display device without performing such scaling.

Even in such a case, in a case where projection is performed in a state in which the optical axis of the projection lens is inclined with respect to the projection face, a trapezoidal distortion occurs, and accordingly, in order to perform the trapezoidal distortion correction, similar problems occur.

### SUMMARY OF THE INVENTION

It is an object of the present invention to at least partially solve the problems in the conventional technology.

There is provided a projection device that includes a projection unit that converts input image data into light and projects a converted image as a projection image onto a projection face with a predetermined view angle; a correction control unit that calculates a correction amount used for eliminating a geometric distortion occurring in the projection image according to a projection direction and determines a cut out range including also an area other than an area of the image data after the geometric distortion correction estimated according to the correction amount based on the correction amount; and a correction unit that generates cut out image data acquired by cutting out an area of the cut out range from the input image data and performs a geometric distortion correction for the cut out image data based on the correction amount.

There is also provided a projection device that includes a projection unit that converts input image data into light and projects a converted image as a projection image onto a projection face with a predetermined view angle; a projection control unit that performs control changing a projection direction of the projection image using the projection unit; a projection angle deriving unit that derives a projection angle of the projection direction; a correction control unit that calculates a correction amount used for correcting a geometric distortion occurring in the projection image according to the projection direction based on the projection angle and the view angle and determines a cut out range including also an area other than an area of the image data after the geometric distortion correction estimated according to the correction amount based on the correction amount; and a correction unit that generates cut out image data acquired by cutting out an area of the cut out range from the input image data and performs a geometric distortion correction for the cut out image data based on the correction amount.

There is further provided an image correction method executed by a projection device, the image correction method including converting input image data into light and projecting a converted image as a projection image onto a projection face with a predetermined view angle using a projection unit; calculating a correction amount used for eliminating a geometric distortion occurring in the projection image according to a projection direction and determining a cut out range including also an area other than an area of the image data after the geometric distortion correction estimated according to the correction amount based on the correction amount; and generating cut out image data acquired by cutting out an area of the cut out range from the input image data and performing a geometric distortion correction for the cut out image data based on the correction amount.

There is also provided an image correction method executed by a projection device, the image correction method including converting input image data into light and projecting a converted image as a projection image onto a projection face with a predetermined view angle using a projection unit; performing control changing a projection direction of the projection image using the projection unit; deriving a projection angle of the projection direction; calculating a correction amount used for correcting a geometric distortion occurring in the projection image according to the projection direction based on the projection angle and the view angle and determining a cut out range including also an area other than an area of the image data after the geometric distortion correction estimated according to the correction amount based on the correction amount; and generating cut out image data acquired by cutting out an area of the cut out range from the input image data and performing a geometric distortion correction for the cut out image data based on the correction amount.

There is further provided a computer readable recording medium that stores therein a computer program causing a computer to execute an image correction method, the method including converting input image data into light and projecting a converted image as a projection image onto a projection face with a predetermined view angle using a projection unit; calculating a correction amount used for eliminating a geometric distortion occurring in the projection image according to a projection direction and determining a cut out range including also an area other than an area of the image data after the geometric distortion correction estimated according to the correction amount based on the correction amount; and generating cut out image data acquired by cutting out an area of the cut out range from the input image data and performing a geometric distortion correction for the cut out image data based on the correction amount. The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1A is a schematic diagram that illustrates an example of the external view of a projector device according to a first embodiment;

FIG. 1B is a schematic diagram that illustrates an example of the external view of the projector device according to the first embodiment;

FIG. 2A is a schematic diagram that illustrates an example of the configuration for performing rotary drive of a drum unit according to the first embodiment;

FIG. 2B is a schematic diagram that illustrates an example of the configuration for performing rotary drive of the drum unit according to the first embodiment;

FIG. 3 is a schematic diagram that illustrates each posture of the drum unit according to the first embodiment;

FIG. 4 is a block diagram that illustrates the functional configuration of the projector device according to the first embodiment;

FIG. 5 is a conceptual diagram that illustrates a cutting out process of image data stored in a memory according to the first embodiment;

FIG. 6 is a schematic diagram that illustrates an example of designation of a cut out area of a case where the drum unit according to the first embodiment is located at an initial position;

FIG. 7 is a schematic diagram that illustrates setting of a cut out area for a projection angle θ according to the first embodiment;

FIG. 8 is a schematic diagram that illustrates designation of a cut out area of a case where optical zooming is performed in accordance with the first embodiment;

FIG. 9 is a schematic diagram that illustrates a case where an offset is given for a projection position of an image according to the first embodiment;

FIG. 10 is a schematic diagram that illustrates access control of a memory according to the first embodiment;

FIG. 11 is a timing diagram that illustrates access control of a memory according to the first embodiment;

FIG. 12A is a schematic diagram that illustrates access control of a memory according to the first embodiment;

FIG. 12B is a schematic diagram that illustrates access control of a memory according to the first embodiment;

FIG. 12C is a schematic diagram that illustrates access control of a memory according to the first embodiment;

FIG. 13A is a schematic diagram that illustrates access control of a memory according to the first embodiment;

FIG. 13B is a schematic diagram that illustrates access control of a memory according to the first embodiment;

FIG. 14 is a diagram that illustrates the relation between a projection direction and a projection image projected onto a screen;

FIG. 15 is a diagram that illustrates the relation between a projection direction and a projection image projected onto a screen;

FIG. 16A is a diagram that illustrates a conventional trapezoidal distortion correction;

FIG. 16B is a diagram that illustrates a conventional trapezoidal distortion correction;

FIG. 17A is a diagram that illustrates cutting out an image of a partial area of input image data according to a conventional technology;

FIG. 17B is a diagram that illustrates cutting out an image of a partial area of input image data according to a conventional technology;

FIG. 18A is a diagram that illustrates problems in a conventional trapezoidal distortion correction;

FIG. 18B is a diagram that illustrates problems in a conventional trapezoidal distortion correction;

FIG. 19 is a diagram that illustrates an image of an unused area remaining after the cutting from the input image data according to a conventional technology;

FIG. 20 is a diagram that illustrates a projection image of a case where a geometric distortion correction according to this embodiment is performed;

FIG. 21 is a diagram that illustrates major projection directions and projection angles of the projection face according to the first embodiment;

FIG. 22 is a graph that illustrates relation between a projection angle and a correction coefficient according to the first embodiment;

FIG. 23 is a diagram that illustrates the calculation of the correction coefficient according to the first embodiment;

FIG. 24 is a diagram that illustrates the calculation of lengths of lines from the upper side to the lower side according to the first embodiment;

FIG. 25 is a diagram that illustrates the calculation of a second correction coefficient according to the first embodiment;

FIG. 26 is a diagram that illustrates the calculation of the second correction coefficient according to the first embodiment;

FIG. 27A is a diagram that illustrates an example of cutting out of image data, image data on a display element, and a projection image in a case where the projection angle is 0° in accordance with the first embodiment;

FIG. 27B is a diagram that illustrates an example of cutting out of image data, image data on a display element, and a projection image in a case where the projection angle is 0° in accordance with the first embodiment;

FIG. 27C is a diagram that illustrates an example of cutting out of image data, image data on a display element, and a projection image in a case where the projection angle is 0° in accordance with the first embodiment;

FIG. 27D is a diagram that illustrates an example of cutting out of image data, image data on a display element, and a projection image in a case where the projection angle is 0° in accordance with the first embodiment;

FIG. 28A is a diagram that illustrates an example of cutting out of image data, image data on a display element, and a projection image in a case where the projection angle is greater than 0°, and a geometric distortion correction is not performed;

FIG. 28B is a diagram that illustrates an example of cutting out of image data, image data on a display element, and a projection image in a case where the projection angle is greater than 0°, and a geometric distortion correction is not performed;

FIG. 28C is a diagram that illustrates an example of cutting out of image data, image data on a display element, and a projection image in a case where the projection angle is greater than 0°, and a geometric distortion correction is not performed;

FIG. 28D is a diagram that illustrates an example of cutting out of image data, image data on a display element, and a projection image in a case where the projection angle is greater than 0°, and a geometric distortion correction is not performed;

FIG. 29A is a diagram that illustrates an example of cutting out of image data, image data on a display element, and a projection image in a case where the projection angle is greater than 0°, and a conventional trapezoidal distortion correction is performed;

FIG. 29B is a diagram that illustrates an example of cutting out of image data, image data on a display element, and a projection image in a case where the projection angle is greater than 0°, and a conventional trapezoidal distortion correction is performed;

FIG. 29C is a diagram that illustrates an example of cutting out of image data, image data on a display element, and a projection image in a case where the projection angle is greater than 0°, and a conventional trapezoidal distortion correction is performed;

FIG. 29D is a diagram that illustrates an example of cutting out of image data, image data on a display element, and a projection image in a case where the projection angle is greater than 0°, and a conventional trapezoidal distortion correction is performed;

FIG. 30A is a diagram that illustrates an example of cutting out of image data, image data on a display element, and a projection image in a case where the projection angle is greater than 0°, and the geometric distortion correction according to this first embodiment is performed;

FIG. 30B is a diagram that illustrates an example of cutting out of image data, image data on a display element, and a projection image in a case where the projection angle is greater than 0°, and the geometric distortion correction according to this first embodiment is performed;

FIG. 30C is a diagram that illustrates an example of cutting out of image data, image data on a display element, and a projection image in a case where the projection angle is greater than 0°, and the geometric distortion correction according to this first embodiment is performed;

FIG. 30D is a diagram that illustrates an example of cutting out of image data, image data on a display element, and a projection image in a case where the projection angle is greater than 0°, and the geometric distortion correction according to this first embodiment is performed;

FIG. 31 is a flowchart that illustrates the sequence of an image projection process according to the first embodiment;

FIG. 32 is a flowchart that illustrates the sequence of an image data cutting out and geometric distortion correction process according to the first embodiment;

FIG. 33 is a flowchart that illustrates the sequence of an image data cutting out and geometric distortion correction process according to a second embodiment;

FIG. 34A is a diagram that illustrates an example of cutting out of image data, image data on a display element, and a projection image in a case where the projection angle is greater than 0°, and the geometric distortion correction according to this second embodiment is performed;

FIG. 34B is a diagram that illustrates an example of cutting out of image data, image data on a display element, and a projection image in a case where the projection angle is greater than 0°, and the geometric distortion correction according to this second embodiment is performed;

FIG. 34C is a diagram that illustrates an example of cutting out of image data, image data on a display element, and a projection image in a case where the projection angle is greater than 0°, and the geometric distortion correction according to this second embodiment is performed; and

FIG. 34D is a diagram that illustrates an example of cutting out of image data, image data on a display element, and a projection image in a case where the projection angle is greater than 0°, and the geometric distortion correction according to this second embodiment is performed.

### DETAILED DESCRIPTION OF THE PREFERRED EMBODIMENTS

Hereinafter, a projection device, an image correction method and a computer-readable recording medium according to embodiments will be described in detail with reference to the accompanying drawings. Specific numerical values, external configurations, and the like represented in the embodiments are merely examples for easy understanding of the present invention but are not for the purpose of limiting the present invention unless otherwise mentioned. In addition, elements not directly relating to the present invention are not described in detail and are not presented in the drawings.

### First Embodiment

### External View of Projection Device

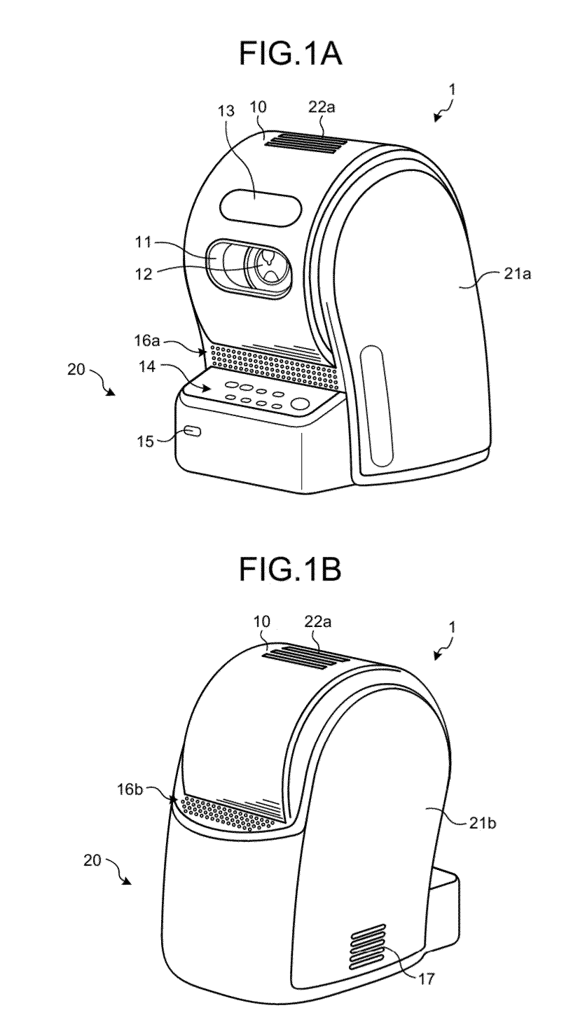

FIGS. 1A and 1B are schematic diagrams that illustrate an example of the external views of a projection device (projector device) 1 according to a first embodiment. FIG. 1A is a perspective view of the projector device 1 viewed from a first face side on which an operation unit is disposed, and FIG. 1B is a perspective view of the projector device 1 viewed from a second face side that is a side facing the operation unit. The projector device 1 includes a drum unit 10 and a base 20. The drum unit 10 is a rotor that is driven to be rotatable with respect to the base 20. In addition, the base 20 includes a support portion supporting the drum unit 10 to be rotatable and a circuit unit performing various control operations such as rotation driving control of the drum unit 10 and image processing control.

The drum unit 10 is supported to be rotatable by a rotation shaft, which is not illustrated in the figure, that is disposed on the inner side of side plate portions 21a and 21b that are parts of the base 20 and is configured by a bearing and the like. Inside the drum unit 10, a light source, a display element that modulates light emitted from the light source based on image data, a drive circuit that drives the display element, an optical engine unit that includes an optical system projecting the light modulated by the display element to the outside, and a cooling means configured by a fan and the like used for cooling the light source and the like are disposed.

In the drum unit 10, window portions 11 and 13 are disposed. The window portion 11 is disposed such that light projected from a projection lens 12 of the optical system described above is emitted to the outside. In the window portion 13, a distance sensor deriving a distance up to a projection medium, for example, using an infrared ray, an ultrasonic wave, or the like is disposed. In addition, the drum unit 10 includes an intake/exhaust hole 22a that performs air in-taking/exhausting for heat rejection using a fan.

Inside the base 20, various substrates of the circuit unit, a power supply unit, a drive unit used for driving the drum unit 10 to be rotated, and the like are disposed. The rotary drive of the drum unit 10 that is performed by this drive unit will be described later. On the first face of the base 20, an operation unit 14 used for a user inputting various operations for controlling the projector device 1 and a reception unit 15 that receives a signal transmitted by a user from a remote control commander not illustrated in the figure when the projector device 1 is remotely controlled are disposed. The operation unit 14 includes various operators receiving user's operation inputs, a display unit used for displaying the state of the projector device 1, and the like.

On the first face side and the second face side of the base 20, the intake/exhaust holes 16a and 16b are respectively disposed. Thus, even in a case where the intake/exhaust hole 22a of the drum unit 10 that is driven to be rotated takes a posture toward the base 20 side, air in-taking or air exhaust can be performed so as not to decrease the rejection efficiency of the inside of the drum unit 10. In addition, the intake/exhaust hole 17 disposed on the side face of the casing performs air in-taking and air exhaust for heat rejection of the circuit unit.

Rotary Drive of Drum Unit

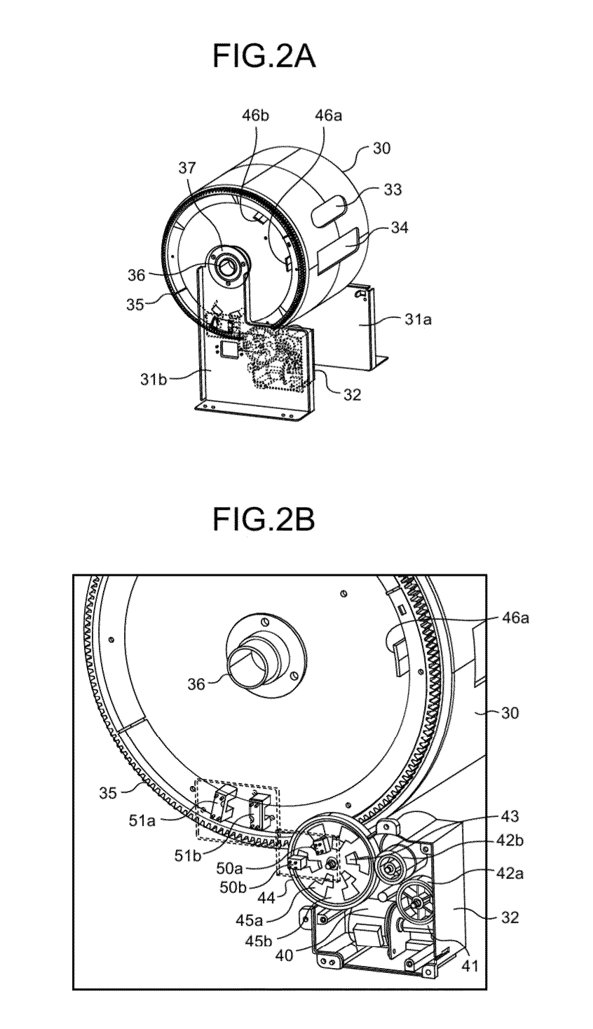

FIGS. 2A and 2B are diagrams that illustrate the rotary drive of the drum unit 10 that is performed by the drive unit 32 disposed in the base 20. FIG. 2A is a diagram that illustrates the configuration of the drum 30 in a state in which a cover and the like of the drum unit 10 are removed and the drive unit 32 disposed in the base 20. In the drum 30, a window portion 34 corresponding to the window portion 11 described above and a window portion 33 corresponding to the window portion 13 are disposed. The drum 30 includes a rotation shaft 36 and is attached to a bearing 37 using bearings disposed in support portions 31a and 31b to be driven to rotate by the rotation shaft 36.

On one face of the drum 30, a gear 35 is disposed on the circumference. The drum 30 is driven to be rotated through the gear 35 by the drive unit 32 disposed in the support portion 31b. Here, protrusions 46a and 46b disposed in the inner circumference portion of the gear 35 are disposed so as to detect a start point and an end point at the time of the rotation operation of the drum 30.

FIG. 2B is an enlarged diagram that illustrates the configuration of the drum 30 and the drive unit 32 disposed in the base 20 in more detail. The drive unit 32 includes a motor 40 and a gear group including a worm gear 41 that is directly driven by the rotation shaft of the motor 40, gears 42a and 42b that transfer rotation according to the worm gear 41, and a gear 43 that transfers the rotation transferred from the gear 42b to the gear 35 of the drum 30. By transferring the rotation of the motor 40 to the gear 35 using the gear group, the drum 30 can be rotated in accordance with the rotation of the motor 40. As the motor 40, for example, a stepping motor performing rotation control for each predetermined angle using a drive pulse may be used.

In addition, photo interrupters 51a and 51b are disposed on the support portion 31b. The photo interrupters 51a and 51b respectively detect the protrusions 46b and 46a disposed in the inner circumference portion of the gear 35. Output signals of the photo interrupters 51a and 51b are supplied to a rotation control unit 104 to be described later. In the embodiment, by detecting the protrusion 46b using the photo interrupter 51a, the rotation control unit 104 determines that the posture of the drum 30 is a posture arriving at an end point of the rotation operation. In addition, by detecting the protrusion 46a using the photo interrupter 51b, the rotation control unit 104 determines that the posture of the drum 30 is a posture arriving at a start point of the rotation operation.

Hereinafter, a direction in which the drum 30 rotates from a position at which the protrusion 46a is detected by the photo interrupter 51b to a position at which the protrusion 46b is detected by the photo interrupter 51a through a longer arc in the circumference of the drum 30 will be represented as a forward direction. In other words, the rotation angle of the drum 30 increases toward the forward direction.

In addition, the photo interrupters 51a and 51b and the protrusions 46a and 46b are arranged such that an angle formed with the rotation shaft 36 is 270° between the detection position at which the photo interrupter 51b detects the protrusion 46a and the detection position at which the photo interrupter 51a detects the protrusion 46b.

For example, in a case where a stepping motor is used as the motor 40, by specifying the posture of the drum 30 based on timing at which the protrusion 46a is detected by the photo interrupter 51b and the number of drive pulses used for driving the motor 40, a projection angle according to the projection lens 12 can be acquired.

Here, the motor 40 is not limited to the stepping motor but, for example, a DC motor may be used. In such a case, for example, as illustrated in FIG. 2B, a code wheel 44 rotating together with the gear 43 on the same shaft as that of the gear 43 is disposed, and photo reflectors 50a and 50b are disposed in the support portion 31b, whereby a rotary encoder is configured.

In the code wheel 44, for example, a transmission portion 45a and a reflection unit 45b having phases changing in the radial direction are disposed. By receiving reflected light having each phase from the code wheel 44 using the photo reflectors 50a and 50b, the rotation speed and the rotation direction of the gear 43 can be detected. Then, based on the rotation speed and the rotation direction of the gear 43 that have been detected, the rotation speed and the rotation direction of the drum 30 are derived. Based on the rotation speed and the rotation direction of the drum 30 that have been derived and a result of the detection of the protrusion 46b that is performed by the photo interrupter 51a, the posture of the drum 30 is specified, whereby the projection angle according to the projection lens 12 can be acquired.

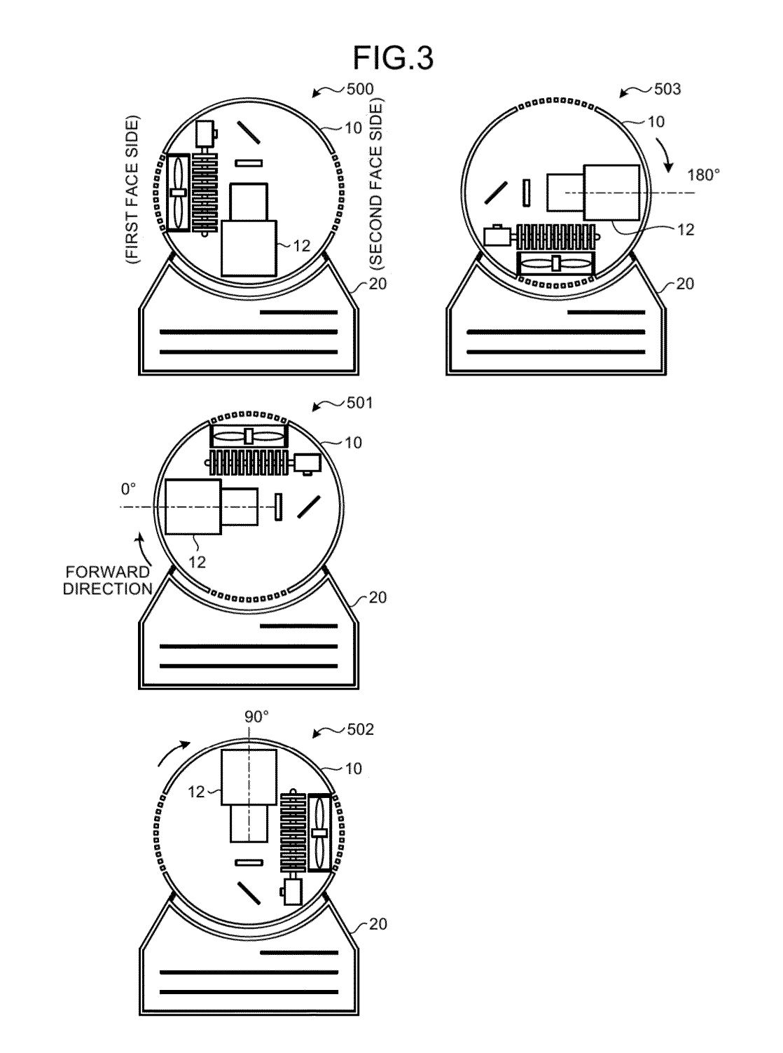

In the configuration as described above, a state in which the projection direction according to the projection lens 12 is in the vertical direction, and the projection lens 12 is completely hidden by the base 20 will be referred to as a housed state (or housing posture). FIG. 3 is a schematic diagram that illustrates each posture of the drum unit 10. In FIG. 3, State 500 illustrates the appearance of the drum unit 10 that is in the housed state. In the embodiment, the protrusion 46a is detected by the photo interrupter 51b in the housed state, and it is determined that the drum 30 arrives at the start point of the rotation operation by the rotation control unit 104 to be described later.

Hereinafter, unless otherwise mentioned, the “direction of the drum unit 10” and the “angle of the drum unit 10” have the same meanings as the “projection direction according to the projection lens 12” and the “projection angle according to the projection lens 12”.

For example, when the projector device 1 is started up, the drive unit 32 starts to rotate the drum unit 10 such that the projection direction according to the projection lens 12 faces the above-described first face. Thereafter, the drum unit 10, for example, is assumed to rotate up to a position at which the direction of the drum unit 10, in other words, the projection direction according to the projection lens 12 is horizontal on the first face side and temporarily stop. The projection angle of the projection lens 12 of a case where the projection direction according to the projection lens 12 is horizontal on the first face side is defined as a projection angle of 0°. In FIG. 3, State 501 illustrates the appearance of the posture of the drum unit 10 (projection lens 12) when the projection angle is 0°. Hereinafter, the posture of the drum unit 10 (projection lens 12) at which the projection angle is θ with respect to the posture having a projection angle of 0° used as the reference will be referred to as a θ posture. In addition, the state of the posture having a projection angle of 0° (in other words, a 0° posture) will be referred to as an initial state.

For example, at the 0° posture, it is assumed that image data is input, and the light source is turned on. In the drum unit 10, light emitted from the light source is modulated based on the image data by the display element driven by the drive circuit and is incident to the optical system. Then, the light modulated based on the image data is projected from the projection lens 12 in a horizontal direction and is emitted to the projection face of the projection medium such as a screen or a wall face.

By operating the operation unit 14 and the like, the user can rotate the drum unit 10 around the rotation shaft 36 as its center while projection is performed from the projection lens 12 based on the image data. For example, by getting the rotation angle to be 90° (90° posture) by rotating the drum unit 10 from the 0° posture in the forward direction, light emitted from the projection lens 12 can be projected vertically upwardly with respect to the bottom face of the base 20. In FIG. 3, State 502 illustrates the appearance of the drum unit 10 at the posture having a projection angle θ of 90°, in other words, a 90° posture.

The drum unit 10 can be rotated further in the forward direction from the 90° posture. In such a case, the projection direction of the projection lens 12 changes from the vertically upward direction with respect to the bottom face of the base 20 to the direction of the second face side. In FIG. 3, State 503 illustrates an appearance acquired when a posture having a projection angle θ of 180°, in other words, a 180° posture is formed as the drum unit 10 further rotates in the forward direction from the 90° posture of State 502. In the projector device 1 according to this embodiment, the protrusion 46b is detected by the photo interrupter 51a in this 180° posture, and it is determined that the drum has arrived at the end point of the rotation operation of the drum 30 by the rotation control unit 104 to be described later.

The projector device 1 according to this embodiment rotates the drum unit 10, for example, as illustrated in States 501 to 503 with projection of an image being performed for easy understanding of description of a change in the projection posture, thereby changing (moving) a projection area of image data in accordance with the projection angle according to the projection lens 12. The change in the projection posture will be described in detail later. Accordingly, changes in the content of a projected image and the projection position of the projected image in the projection medium and changes in the content and the position of the image area cut out as an image to be projected from the whole image area relating to input image data can be associated with each other. Accordingly, a user can intuitively perceive an area which is projected out of the whole image area relating to the input image data based on the position of the projected image in the projection medium and intuitively perform an operation of changing the content of the projected image.

In addition, the optical system includes an optical zoom mechanism and can enlarge or reduce the size at the time of projecting a projection image to the projection medium by operating the operation unit 14. Hereinafter, the enlarging or reducing of the size at the time of projecting the projection image to the projection medium according to the optical system may be simply referred to as “zooming”. For example, in a case where the optical system performs zooming, the projection image is enlarged or reduced with the optical axis of the optical system at the time point of performing zooming being as its center.

When the user ends the projection of the projection image using the projector device 1 and stops the projector device 1 by performing an operation for instructing the operation unit 14 to stop the projector device 1, first, rotation control is performed such that the drum unit 10 is returned to be in the housed state. When drum unit 10 is positioned toward the vertical direction, and the return of the drum unit 10 into the housed state is detected, the light source is turned off, and, after a predetermined time required for cooling the light source, the power is turned off. By turning the power off after the drum unit 10 is positioned toward the vertical direction, the projection lens 12 can be prevented from getting dirty when the projection lend is not used.

Functional Configuration of Projector Device 1

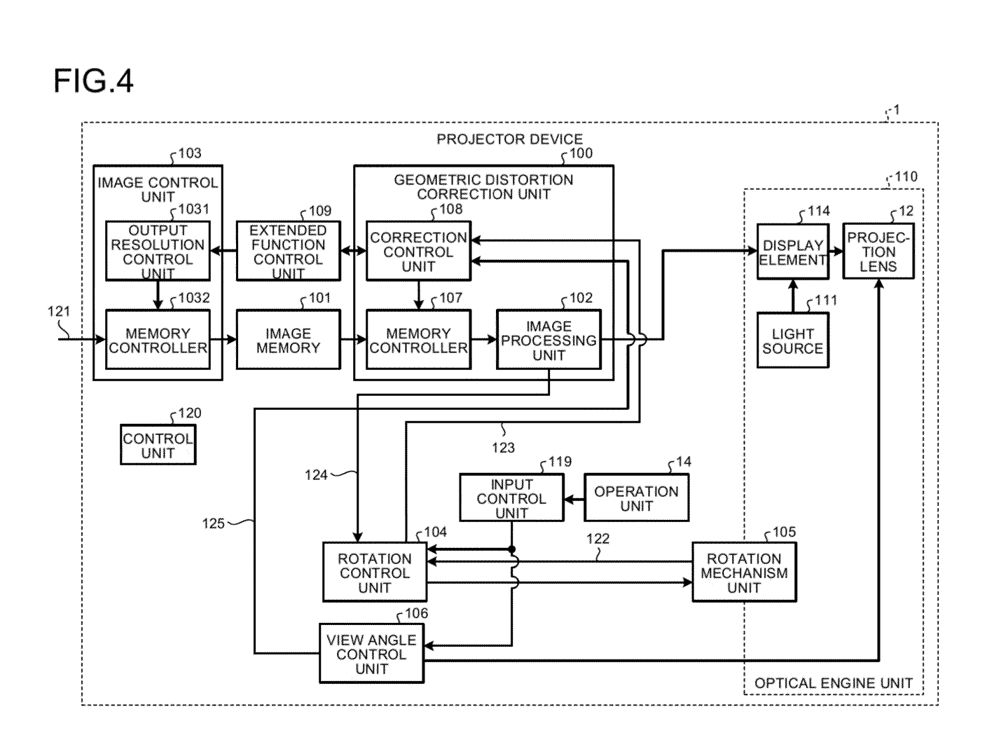

Next, a configuration for realizing each function or operation of the projector device 1 according to this embodiment, as described above, will be described. FIG. 4 is a block diagram that illustrates the functional configuration of the projector device 1.

As illustrated in FIG. 4, the projector device 1 mainly includes: an optical engine unit 110, a rotation mechanism unit 105; a rotation control unit 104; a view angle control unit 106; an image control unit 103; an extended function control unit 109; an image memory 101; a geometric distortion correction unit 100; an input control unit 119; a control unit 120; and an operation unit 14. Here, the optical engine unit 110 is disposed inside the drum unit 10. In addition, the rotation control unit 104, the view angle control unit 106, the image control unit 103, the extended function control unit 109, the image memory 101, the geometric distortion correction unit 100, the input control unit 119, and the control unit 120 are mounted on the substrates of the base 20 as a circuit unit.

The optical engine unit 110 includes a light source 111, a display element 114, and a projection lens 12. The light source 111, for example, includes three light emitting diodes (LEDs) respectively emitting red (R) light, green (G) light, and blue (B) light. Luminous fluxes of colors RGB that are emitted from the light source 111 irradiate the display element 114 through an optical system not illustrated in the figure.

In description presented below, the display element 114 is assumed to be a transmission-type liquid crystal display device and, for example, to have a size of horizontal 1280 pixels×vertical 720 pixels. However, the size of the display element 114 is not limited to this example. The display element 114 is driven by a drive circuit not illustrated in the figure and modulates luminous fluxes of the colors RGB based on image data and emits the modulated luminous fluxes. The luminous fluxes of the colors RGB that are emitted from the display element 114 and are modulated based on the image data are incident to the projection lens 12 through the optical system not illustrated in the figure and are projected to the outside of the projector device 1.

In addition, the display element 114, for example, may be configured by a reflection-type liquid crystal display device using liquid crystal on silicon (LCOS) or a digital micromirror device (DMD). In such a case, the projector device is configured by an optical system and a drive circuit that correspond to the used display element.

The projection lens 12 includes a plurality of lenses that are combined together and a lens driving unit that drives the lenses according to a control signal. For example, the lens driving unit drives a lens included in the projection lens 12 based on a result of distance measurement that is acquired based on an output signal output from a distance sensor disposed in the window portion 13, thereby performing focus control. In addition, the lens driving unit changes the view angle by driving the lens in accordance with a zoom instruction supplied from the view angle control unit 106 to be described later, thereby controlling the optical zoom.

As described above, the optical engine unit 110 is disposed inside the drum unit 10 that can be rotated by 360° by the rotation mechanism unit 105. The rotation mechanism unit 105 includes the drive unit 32 and the gear 35 that is a configuration of the drum unit 10 side described with reference to FIGS. 2A and 2B, and rotates the drum unit 10 in a predetermined manner using the rotation of the motor 40. In other words, the projection direction of the projection lens 12 is changed by the rotation mechanism unit 105.

The input control unit 119 receives a user operation input from the operation unit 14 as an event. The control unit 120 performs overall control of the projector device 1.

The rotation control unit 104, for example, receives an instruction according to a user operation for the operation unit 14 through the input control unit 119 and instructs the rotation mechanism unit 105 based on the instruction according to the user operation. The rotation mechanism unit 105 includes the drive unit 32 and the photo interrupters 51a and 51b described above. The rotation mechanism unit 105 controls the drive unit 32 according to an instruction supplied from the rotation control unit 104, thereby controlling the rotation operation of the drum unit (drum 30). For example, the rotation mechanism unit 105 generates a drive pulse according to an instruction supplied from the rotation control unit 104 and drives the motor 40 that is, for example, a stepping motor.

Meanwhile, outputs of the photo interrupters 51a and 51b described above and a drive pulse 122 used for driving the motor 40 are supplied from the rotation mechanism unit 105 to the rotation control unit 104. The rotation control unit 104, for example, includes a counter and counts the pulse number of the drive pulses 122. The rotation control unit 104 acquires the timing of detection of the protrusion 46a based on the output of the photo interrupter 51b and resets the pulse number counted by the counter at the timing of the detection of the protrusion 46a. The rotation control unit 104, based on the pulse number counted by the counter, can sequentially acquire the angle of the drum unit 10 (drum 30), thereby acquiring the posture (in other words, the projection angle of the projection lens 12) of the drum unit 10. The projection angle of the projection lens 12 is supplied to the geometric distortion correction unit 100. In this way, in a case where the projection direction of the projection lens 12 is changed, the rotation control unit 104 can derive an angle between a projection direction before change and a projection angle after the change.

The view angle control unit 106, for example, receives an instruction according to a user operation for the operation unit 14 through the input control unit 119 and gives a zoom instruction, in other words, an instruction for changing the view angle to the projection lens 12 based on an instruction according to the user operation. The lens driving unit of the projection lens 12 drives the lens based on the zoom instruction, thereby performing zoom control. The view angle control unit 106 supplies the zoom instruction and a view angle derived based on a zoom magnification relating to the zoom instruction and the like to the geometric distortion correction unit 100.

The image control unit 103 receives input image data 121 as input and stores the input image data in the image memory 101 with designated output resolution. The image control unit 103, as illustrated in FIG. 4, includes an output resolution control unit 1031 and a memory controller 1032.

The output resolution control unit 1031 receives resolution from the geometric distortion correction unit 100 through the extended function control unit 109 and outputs the received resolution to the memory controller 1032 as output resolution.

The memory controller 1032 receives the input image data 121 of 1920 pixels×1080 pixels, which is a still image or a moving image, as input and stores the input image data 121 of 1920 pixels×1080 pixels that has been input in the image memory 101 with the output resolution input from the output resolution control unit 1031.

The image memory 101 stores the input image data 121 in units of images. In other words, for each still image in a case where the input image data 121 is still image data and for each frame image configuring moving image data in a case where the input image data 121 is the moving image data, corresponding data is stored. The image memory 101, for example, in compliance with the standards of digital high vision broadcasting, can store one or a plurality of frame images of 1920 pixels and 1080 pixels.

In addition, it is preferable that the size of the input image data 121 is shaped in advance into a size corresponding to the storage unit of the image data in the image memory 101, and resultant input image data is input to the projector device 1. In this example, the size of the input image data 121 is shaped into 1920 pixels×1080 pixels, and resultant input image is input to the projector device 1. However, the configuration is not limited thereto, but an image shaping unit that shapes the input image data 121 input with an arbitrary size into image data of a size of 1920 pixels and 1080 pixels may be disposed in a previous stage of the memory controller 1032 in the projector device 1.

The geometric distortion correction unit 100 calculates a first correction coefficient relating to a horizontal correction of the geometric distortion and a second correction coefficient relating to a vertical correction, acquires a cut out range, cuts out an image of an area of the cut range from the input image data 121 stored in the image memory 101, performs a geometric distortion correction and image processing for the image, and outputs a resultant image to the display element 114.

The geometric distortion correction unit 100, as illustrated in FIG. 4, includes a correction control unit 108, a memory controller 107, and an image processing unit 102.

The correction control unit 108 receives a projection angle 123 from the rotation control unit 104 as input and receives a view angle 125 from the view angle control unit 106 as input. Then, the correction control unit 108 calculates the first correction coefficient and the second correction coefficient used for eliminating a geometric distortion occurring in the projection image according to the projection direction based on the projection angle 123 and the view angle 125 that have been input and outputs the first correction coefficient and the second correction coefficient to the memory controller 107.

In addition, the correction control unit 108 determines a cut out range from the input image data such that the size of the image data after the geometric distortion correction includes a displayable size of the display device based on the projection angle 123, the view angle 125, the first correction coefficient, and the second correction coefficient and outputs the determined cut out range to the memory controller 107 and the extended function control unit 109. At this time, the correction control unit 108 designates a cut out area of the image data based on the angle of the projection direction of the projection lens 12.

The memory controller 107 cuts out (extracts) an image area of the cut out range determined by the correction control unit 108 from the whole area of a frame image relating to the image data stored in the image memory 101 and outputs the cut out image area as image data.

In addition, the memory controller 107 performs a geometric distortion correction for the image data cut out from the image memory 101 by using the first correction coefficient and the second correction coefficient and outputs the image data after the geometric distortion correction to the image processing unit 102. Here, the first correction coefficient, the second correction coefficient, and the geometric distortion correction will be described in detail later.

The image data output from the memory controller 107 is supplied to the image processing unit 102. The image processing unit 102, for example, by using a memory not illustrated in the figure, performs image processing for the supplied image data and outputs the image data for which the image processing has been performed to the display element 114 as image data of 1280 pixels×720 pixels. The image processing unit 102 outputs the image data for which the image processing has been performed based on timing represented in a vertical synchronization signal 124 supplied from a timing generator not illustrated in the figure. The image processing unit 102, for example, performs a size converting process for the image data supplied from the memory controller 107 such that the size matches the size of the display element 114. In addition, other than the process, the image processing unit 102 may perform various kinds of image processing. For example, the image processing unit 102 may perform a size converting process for the image data using a general linear transformation process. In addition, in a case where the size of the image data supplied from the memory controller 107 matches the size of the display element 114, the image data may be directly output.

In addition, by performing interpolation (over sampling) with the aspect ratio of the image being maintained to be constant, a part or the whole of the image may be enlarged through an interpolation filter having a predetermined characteristic, in order to extract an aliasing distortion, by thinning (sub sampling) the image through a low pass filter according to a reduction rate, a part or the whole of the image may be reduced, or the image may be configured to maintain the size without passing through a filter.

Furthermore, when an image is projected in an inclined direction, in order to prevent an image from being blurred due to out-of focus on a periphery portion, an edge enhancement process using an operator such as Laplacian or an edge enhancement process applying one-dimensional filters in horizontal and vertical directions may be performed. Through this edge enhancement process, the edge of a blurred image portion that is projected can be enhanced.

In addition, in a case where a periphery portion of a projected image texture includes a diagonal line, in order not to allow an edge jag to be visually noticed, by mixing a local halftone or applying a local low pass filter using the image processing unit 102, the edge jag is shaded off, whereby the diagonal line can be prevented from being observed as a jagged line.

The image data output from the image processing unit 102 is supplied to the display element 114. Actually, this image data is supplied to the drive circuit that drives the display element 114. The drive circuit drives the display element 114 based on the supplied image data.

The extended function control unit 109 receives a cut out range from the correction control unit 108 as input and outputs resolution including the cut out range to the output resolution control unit 1031 as output resolution.

Cutting Out Process of Image Data

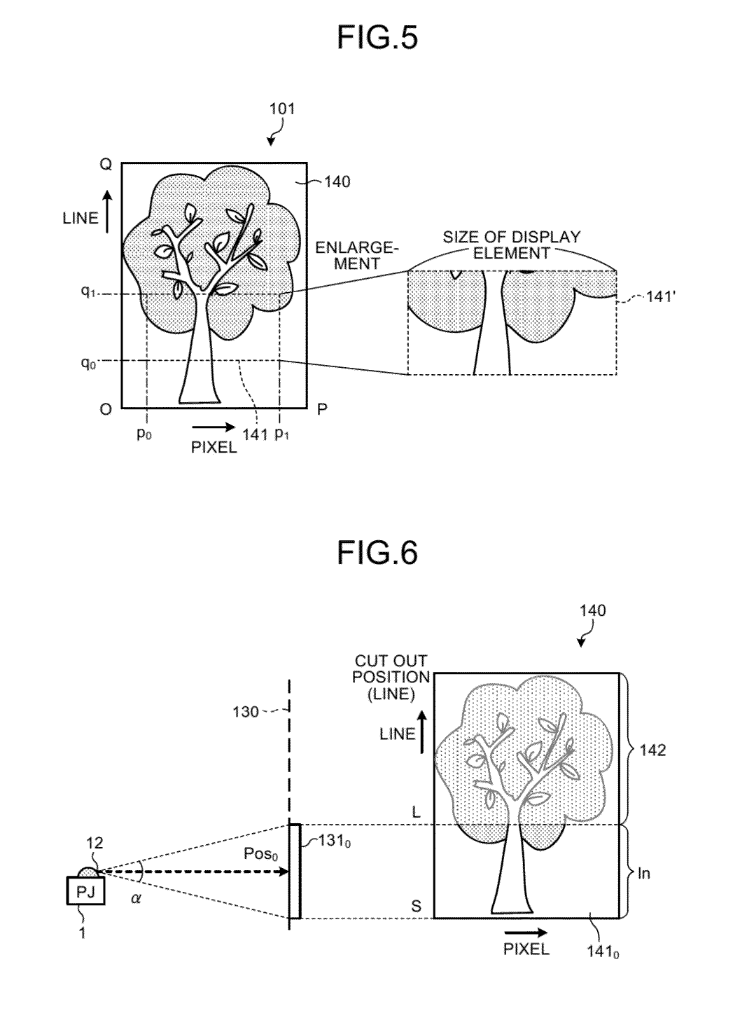

Next, a cutting out process of image data stored in the image memory 101 that is performed by the memory controller 107 according to this embodiment will be described. FIG. 5 is a conceptual diagram that illustrates the cutting out process of image data stored in the image memory 101. An example of cutting out the image data 141 of the cut out area designated from the image data 140 stored in the image memory 101 will be described with reference to a left diagram in FIG. 5. In description presented below with reference to FIGS. 6 to 9, for simple description, a case where a geometric distortion correction is not performed for the image data and a case where the pixel size of the image data in the horizontal direction coincides with the pixel size of the display element 114 in the horizontal direction will be premised.

In the image memory 101, for example, addresses are set in the vertical direction in units of lines and are set in the horizontal direction in units of pixels. In addition, it is assumed that the address of a line increases from the lower end of an image (screen) toward the upper end thereof, and the address of a pixel increases from the left end of the image toward the right end thereof.

The correction control unit 108, for the memory controller 107, designates addresses of lines q₀ and q₁ in the vertical direction and designates addresses of pixels p₀ and p₁ in the horizontal direction as a cut out area of image data 140 of Q lines×P pixels stored in the image memory 101. The memory controller 107 reads lines within the range of the lines q₀ and q₁ over the pixels p₀ and p₁ from the image memory 101 in accordance with the designation of the addresses. At this time, as the sequence of reading, for example, it is assumed that the lines are read from the upper end toward the lower end of the image, and the pixels are read from the left end toward the right end of the image. The access control for the image memory 101 will be described in detail later.

The memory controller 107 supplies the image data 141 of the range of the lines q₀ and q₁ and the pixels p₀ and p₁, which has been read from the image memory 101, to the image processing unit 102. The image processing unit 102 performs a size conversion process in which the size of an image according to the supplied image data 141 is adjusted to the size of the display element 114. As an example, in a case where the size of the display element 114 is V lines×H pixels, a maximum multiplication m satisfying both Equations (1) and (2) as represented below is acquired. Then, the image processing unit 102 enlarges the image data 141 with this multiplication m and, as illustrated in FIG. 5 as an example, size-converted image data 141′ is acquired.

m×(p₁−p₀)≦H (1)

m×(q₁−q₀)≦V (2)

Next, the designation (update) of a cut out area according to the projection angle according to this embodiment will be described. FIG. 6 illustrates an example of designation of a cut-out area of a case where the drum unit 10 is at the 0° posture, in other words, in a case where the projection angle is 0° that is in the initial state.

In FIG. 5 described above, a case has been described as an example in which the image data 141 of the range between the pixels p₀ and p₁ that is a partial range of pixels of one line of the image data 140 of Q lines×P pixels stored in the image memory 101 is cut out. Also in examples illustrated in FIGS. 6 to 8, actually, pixels of a partial range of one line of the image data 140 stored in the image memory 101 may be cut out. However, in order to simplify the description of the designation (update) of a cut out area according to the projection angle, in the examples represented in FIGS. 6 to 8 illustrated below, all the pixels of one line are assumed to be cut out.

In the projector device (PJ) 1, a projection position of a case where an image 131₀ is projected with a projection angle of 0° onto a projection face 130 that is a projection medium such as a screen by using a projection lens 12 having a view angle α is assumed to be a position Pos₀ corresponding to the luminous flux center of light projected from the projection lens 12. In addition, at the projection angle of 0°, an image according to image data from the S-th line that is the lower end of an area designated in advance to the L-th line is assumed to be projected such that the image data stored in the image memory 101 is projected at the posture of a projection angle of 0°. In the area formed by lines of the S-th line to the L-th line, lines corresponding to the line number ln are included. In addition, a value representing a line position such as the S-th line or the L-th line, for example, is a value increasing from the lower end toward the upper end of the display element 114 with the line positioned at the lower end of the display element 114 set as the 0-th line.

Here, the line number ln is the number of lines of a maximal effective area of the display element 114. In addition, the view angle α is an angle for viewing a projection image in the vertical direction from the projection lens 12 in a case where the image is projected when an effective area in the vertical direction, in which the display is effective in the display element 114, has a maximum value, in other words, in a case where an image of the line number ln is projected.

The view angle α and the effective area of the display element 114 will be described using a more specific example. The display element 114 is assumed to have a vertical size of 720 lines. For example, in a case where the vertical size of the projection image data is 720 lines, and projection image data is projected using all the lines of the display element 114, the effective area of the display element 114 in the vertical direction has a maximum value of 720 lines (=line number ln). In this case, the view angle α is an angle for viewing 1st to 720th lines of the projection image from the projection lens 12.

In addition, a case may be also considered in which the vertical size of projection image data is 600 lines, and the projection image data is projected using only 600 lines out of 720 lines (=line number ln) of the display element 114. In such a case, the effective area of the display element 114 in the vertical direction is 600 lines. In this case, only a portion of the effective area according to the projection image data with respect to a maximal value of the effective area of the view angle α is projected.

The correction control unit 108 instructs the memory controller 107 to cut out and read the S-th line to L-th line of the image data 140 stored in the image memory 101. Here, in the horizontal direction, all the image data 140 of the left end to the right end is read. The memory controller 107 sets an area of the S-th line to the L-th line of the image data 140 as a cut out area in accordance with an instruction from the correction control unit 108, reads the image data 141 of the set cut out area, and supplies the read image data to the image processing unit 102. In the example illustrated in FIG. 6, onto the projection face 130, an image 131₀ according to image data 141₀ of the line number ln from the S-th line to the L-th line of the image data 140 is projected. In such a case, an image according to image data 142 of an area relating to the L-th line to the upper-end line out of the whole area of the image data 140 is not projected.

Next, a case will be described in which the drum unit 10 is rotated, for example, according to a user operation for the operation unit 14, and the projection angle of the projection lens 12 becomes an angle θ. In this embodiment, in a case where the drum unit 10 is rotated, and the projection angle according to the projection lens 12 is changed, the cut out area from the image memory 101 of the image data 140 is changed in accordance with the projection angle θ.

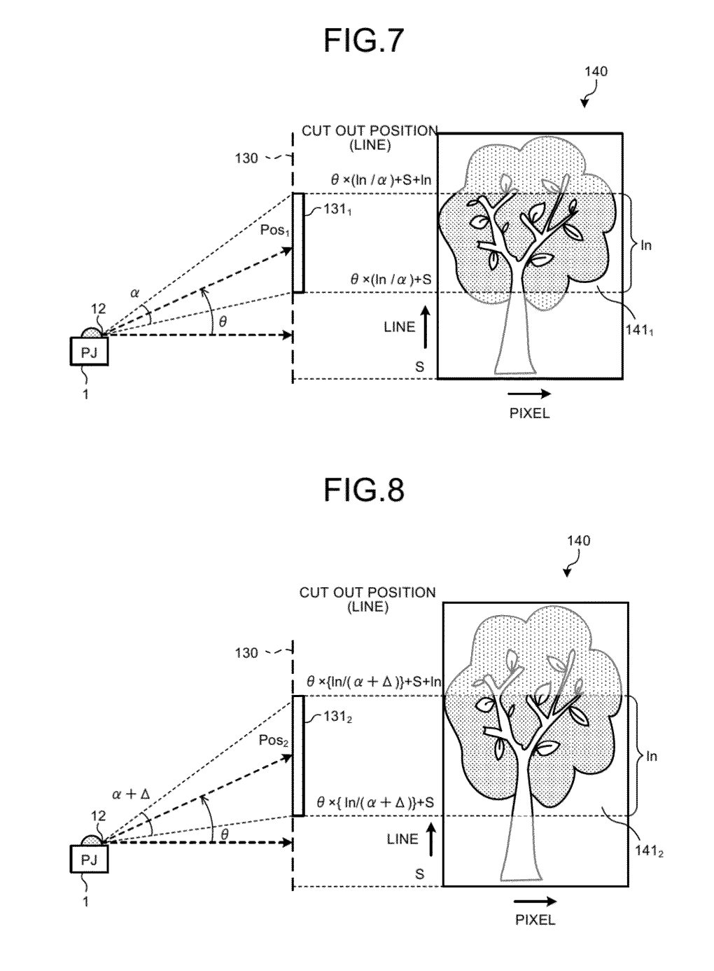

The setting of a cut out area for the projection angle θ will be described more specifically with reference to FIG. 7. For example, a case will be considered in which the drum unit 10 is rotated in the forward direction from a projection position of the 0° posture according to the projection lens 12, and the projection angle of the projection lens 12 becomes an angle θ (>0°). In such a case, the projection position for the projection face 130 moves to a projection position Pos₁ that is located on the upper side of a projection position Pos₀ corresponding to a projection angle of 0°. At this time, the correction control unit 108, for the memory controller 107, designates a cut out area for the image data 140 stored in the image memory 101 based on the following Equations (3) and (4). Equation (3) represents an R_{S}-th line located at the lower end of the cut out area, and Equation (4) represents an R_{L}-th line located at the upper end of the cut out area.

R_{S}=0×(ln/α)+S (3)

R_{L}=0×(ln/α)+S+ln (4)

In Equations (3) and (4), a value ln represents the number of lines (for example, the number of lines of the display element 114) included within the projection area. In addition, a value α represents a view angle of the projection lens 12, and a value S represents a position of a line located at the lower end of the cut out area at the 0° posture described with reference to FIG. 6.

In Equations (3) and (4), (ln/α) represents the number of lines (including a concept of an approximately averaged number of lines changing in accordance with the shape of the projection face) per unit angle of a case where the view angle α projects the line number ln. Accordingly, θ×(ln/α) represents the number of lines corresponding to the projection angle θ according to the projection lens 12 in the projector device 1. This means that, when the projection angle changes by an angle Δθ, the position of the projection image is moved by a distance corresponding to the number of lines {Δθ×(ln/α)} in the projection image. Accordingly, Equations (3) and (4) respectively represent the positions of lines located at the lower end and the upper end of the image data 140 in the projection image of a case where the projection angle is the angle θ. This corresponds to a read address for the image data 140 on the memory 101 at the projection angle θ.

In this way, in this embodiment, an address at the time of reading the image data 140 from the image memory 101 is designated in accordance with the projection angle θ. Accordingly, image data 141₁ of the image data 140 that is located at a position corresponding to the projection angle θ is read from the image memory 101, and an image 131₁ relating to the read image data 141₁ is projected to the projection position Pos₁ corresponding to the projection angle θ of the projection face 130.

Thus, according to this embodiment, in a case where the image data 140 having a size larger than the size of the display element 114 is projected, a correspondence relation between the position within the projected image and the position within the image data is maintained. In addition, since the projection angle θ is acquired based on a drive pulse of the motor 40 used for driving the drum 30 to be rotated, the projection angle θ can be acquired in a state in which there is substantially no delay with respect to the rotation of the drum unit 10, and the projection angle θ can be acquired without being influenced by the projection image or the surrounding environment.

Next, the setting of a cut out area of a case where optical zooming according to the projection lens 12 is performed will be described. As described above, in the case of the projector device 1, the view angle α of the projection lens 12 is increased or decreased by driving the lens driving unit, whereby optical zooming is performed. An increase in the view angle according to the optical zooming is assumed to be an angle Δ, and the view angle of the projection lens 12 after the optical zooming is assumed to be a view angle (α+Δ).

In such a case, even when the view angle is increased according to the optical zooming, the cut out area for the image memory 101 does not change. In other words, the number of lines included in a projection image according to the view angle α before the optical zooming and the number of lines included in a projection image according to the view angle (α+Δ) after the optical zooming are the same. Accordingly, after the optical zooming, the number of lines included per unit angle is changed from that before the optical zooming.

The setting of a cut out area of a case where optical zooming is performed will be described more specifically with reference to FIG. 8. In the example illustrated in FIG. 8, optical zooming is performed in which the view angle α is increased by an amount corresponding to the view angle Δ in the state of the projection angle θ. By performing the optical zooming, for example, a projection image projected onto the projection face 130, as illustrated as an image 131₂, is enlarged by an amount corresponding to the view angle Δ with respect to that of a case where the optical zooming is not performed with the center (the projection position Pos₂) of the luminous fluxes of light projected to the projection lens 12 in common.

In a case where optical zooming corresponding to the view angle Δ is performed, when the number of lines designated as a cut out area for the image data 140 is ln, the number of lines included per unit angle is represented by {ln/(α+Δ)}. Accordingly, the cut out area for the image data 140 is designated based on the following Equations (5) and (6). The meaning of each variable in Equations (5) and (6) is common to that in Equations (3) and (4) described above.

R_{S}=0×{ln/(α+Δ)}+S (5)

R_{L}=0×{ln/(α+Δ)}+S+ln (6)

Image data 141₂ of an area represented in Equations (5) and (6) is read from the image data 140, and an image 131₂ relating to the read image data 141₂ is projected to a projection position Pos₂ of the projection face 130 by the projection lens 12.

In this way, in a case where optical zooming is performed, the number of lines included per unit angle is changed with respect to a case where the optical zooming is not performed, and the amount of change in the number of lines with respect to a change in the projection angle θ is different from that of a case where the optical zooming is not performed. This is a state in which a gain corresponding to the view angle Δ increased according to the optical zooming is changed in the designation of a read address according to the projection angle θ for the image memory 101.

In this embodiment, an address at the time of reading the image data 140 from the image memory 101 is designated in accordance with the projection angle θ and the view angle α of the projection lens 12. In this way, even in a case where optical zooming is performed, the address of the image data 141₂ to be projected can be appropriately designated for the image memory 101. Accordingly, even in a case where the optical zooming is performed, in a case where the image data 140 of a size larger than the size of the display element 114 is projected, a correspondence relation between the position within the projected image and the position within the image data is maintained.

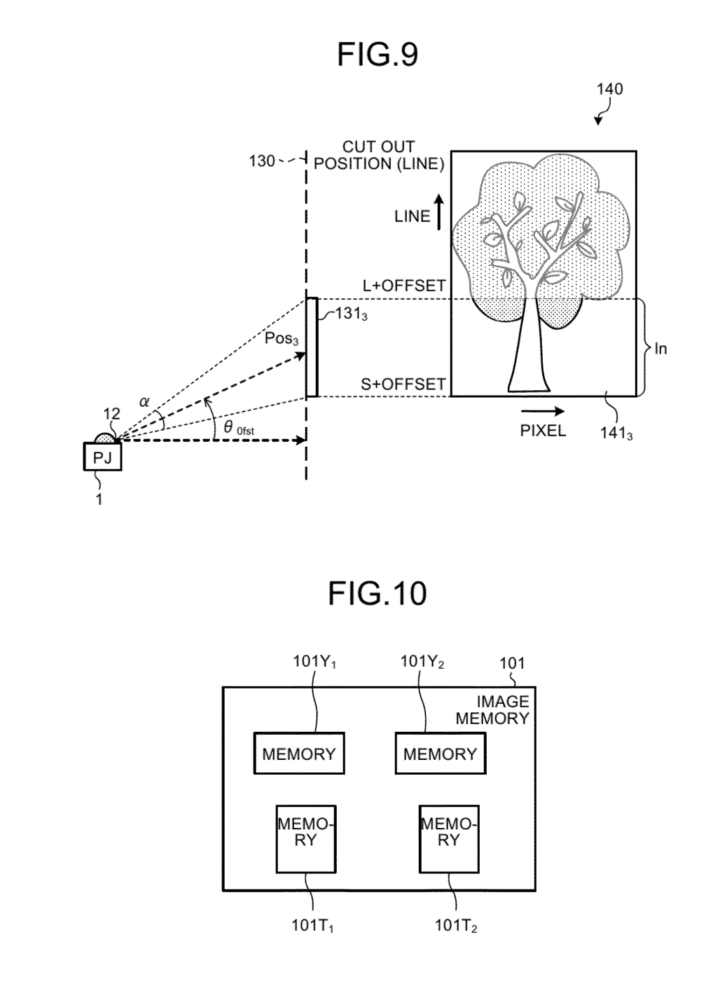

Next, a case will be described with reference to FIG. 9 in which an offset is given to the projection position of the image. When the projector device 1 is used, it cannot be determined that the 0° posture (projection angle 0°) is necessarily the lowest end of the projection position. For example, as illustrated in FIG. 9, a case may be considered in which a projection position Pos₃ according to a predetermined projection angle θ_{ofst} is set as the projection position located at the lowest end. In such a case, the image 131₃ according to the image data 141₃ is projected to a position shifted to the upper side by a height corresponding to the projection angle θ_{ofst} compared to a case where the offset is not given. The projection angle θ at the time of projecting an image having a line located at the lowest end of the image data 140 as its lowest end is set as the offset angle θ_{ofst} according to the offset.

In such a case, for example, a case may be considered in which the offset angle θ_{ofst} is regarded as the projection angle 0°, and a cut out area for the image memory 101 is designated. By applying Equations (3) and (4) described above, the following Equations (7) and (8) are formed. The meaning of each variable in Equations (7) and (8) is common to that in Equations (3) and (4) described above.

R_{S}=(θ−θ_{ofst})×(ln/α)+S (7)

R_{L}=(θ−θ_{ofst})×(ln/α)+S+ln (8)

The image data 141₃ of the area represented in Equations (7) and (8) is read from the image data 140, and the image 131₃ relating to the read image data 141₃ is projected to the projection position Pos₃ of the projection face 130 by the projection lens 12.

Memory Control

Next, access control of the image memory 101 will be described with reference to FIGS. 10 to 13. Here, also in the description presented below with reference to FIGS. 10 to 13, in order to simplify the description, a case will be premised for the description in which a geometric distortion correction is not performed for the image data.

In the image data, for each vertical synchronization signal VD, pixels are sequentially transmitted from the left end toward the right end of an image for each line in the horizontal direction on the screen, and lines are sequentially transmitted from upper end toward the lower end of the image. Hereinafter, a case will be described as an example in which the image data has a size of horizontal 1920 pixels×vertical 1080 pixels (lines) corresponding to the digital high vision standard.

Hereinafter, an example of the access control of a case where the image memory 101 includes four memory areas for which the access control can be independently performed will be described. In other words, as illustrated in FIG. 10, in the image memory 101, areas of memories 101Y₁ and 101Y₂ used for writing and reading image data with a size of horizontal 1920 pixels and vertical 1080 pixels (line) and areas of memories 101T₂ and 101T₂ used for writing and reading image data with a size of horizontal 1080 pixels×vertical 1920 pixels (lines) are arranged. Hereinafter, the memories 101Y₁, 101Y₂, 101T₂, and 101T₂ will be described as memories Y₁, Y₂, T₁, and T₂.

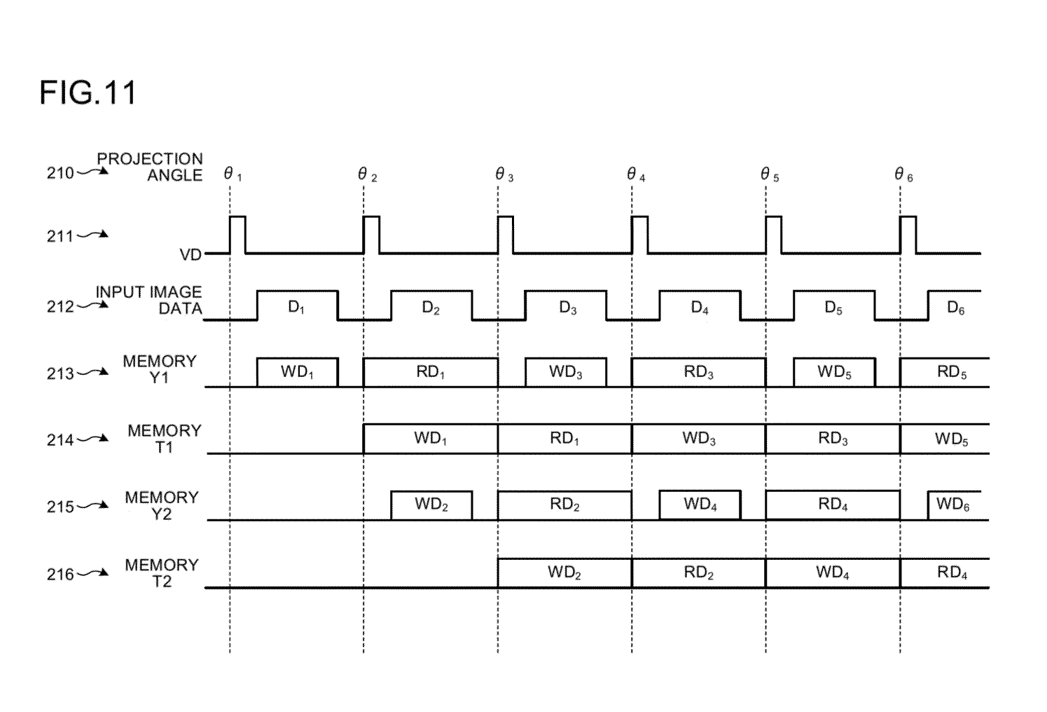

FIG. 11 is a timing diagram that illustrates access control of the image memory 101 using the memory controller 107 according to the first embodiment. Chart 210 represents the projection angle θ of the projection lens 12, and Chart 211 represents the vertical synchronization signal VD. In addition, Chart 212 represents input timings of image data D₁, D₂, and . . . input to the memory controller 107, and Charts 213 to 216 represent examples of accesses to the memories Y₁, Y₂, T₁ and T₂ from the memory controller 107. In addition, in Charts 213 to 216, each block to which “R” is attached represents reading, and each block to which “W” is attached represents writing.

For every vertical synchronization signal VD, image data D₁, D₂, D₃, D₄, D₅, D₆, . . . each having an image size of 1920 pixels×1080 lines are input to the memory controller 107. Each of the image data D₁, D₂, . . . is synchronized with the vertical synchronization signal VD and is input after the vertical synchronization signal VD. In addition, the projection angles of the projection lens 12 corresponding to the vertical synchronization signals VD are denoted as projection angles θ₁, θ₂, θ₃, θ₄, θ₅, θ₆, . . . . The projection angle θ is acquired for every vertical synchronization signal VD as above.

First, the image data D₁ is input to the memory controller 107. As described above, the projector device 1 according to this embodiment changes the projection angle θ according to the projection lens 12 by rotating the drum unit 10 so as to move the projection position of the projection image and designates a read position for the image data in accordance with the projection angle θ. Accordingly, it is preferable that the image data is longer in the vertical direction. Generally, image data frequently has a horizontal size longer than a vertical size. Thus, for example, it may be considered for a user to rotate the camera by 90° in an imaging process and input image data acquired by the imaging process to the projector device 1.

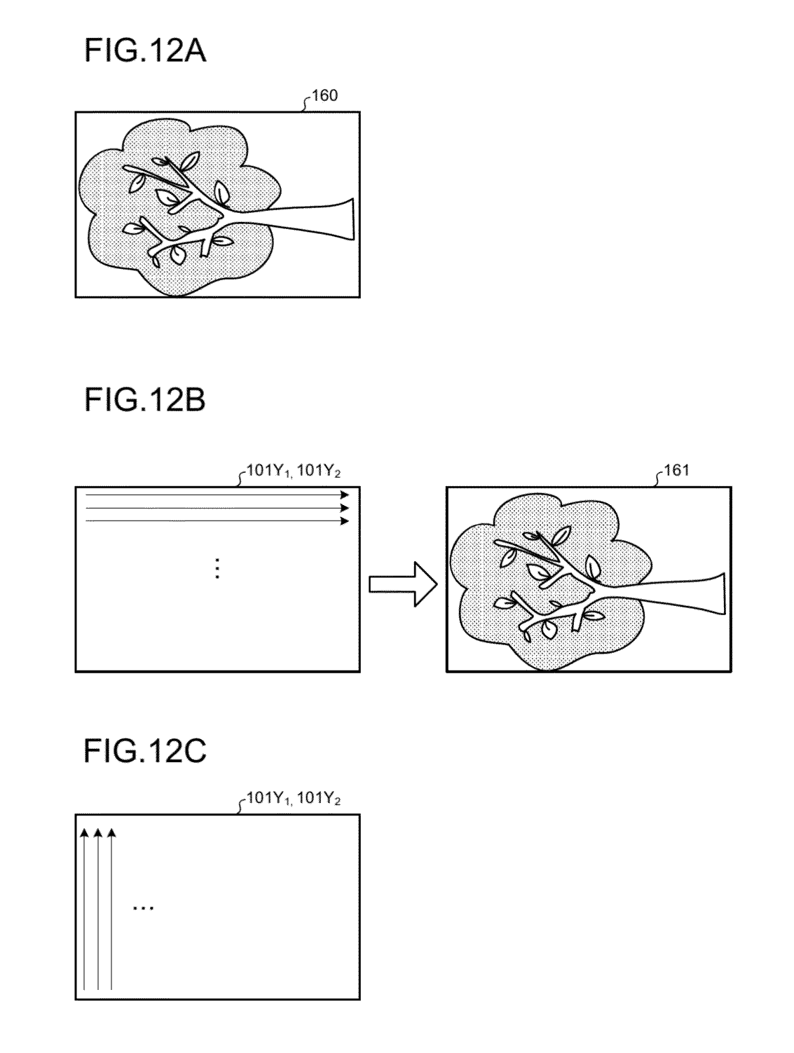

In other words, an image according to the image data D₁, D₂, . . . input to the memory controller 107, similarly to an image 160 illustrated as an image in FIG. 12A, is a sideways image acquired by rotating a right-direction image by 90° that is determined based on the content of the image.

The memory controller 107 writes the input image data D₁ into the memory Y₁ at timing WD₁ corresponding to the input timing of the image data D₁ (timing WD₁ illustrated in Chart 213). The memory controller 107 writes the image data D₁ into the memory Y₁, as illustrated on the left side of FIG. 12B, in the sequence of lines toward the horizontal direction. On the right side of FIG. 12B, an image 161 according to the image data D₁ written into the memory Y₁ as such is illustrated as an image. The image data D₁ is written into the memory Y₁ as the image 161 that is the same as the input image 160.

The memory controller 107, as illustrated in FIG. 12C, reads the image data D₁ written into the memory Y₁ from the memory Y₁ at timing RD₁ that is the same as the timing of start of a next vertical synchronization signal VD after the vertical synchronization signal VD for writing the image data D₁ (timing RD₁ illustrated in Chart 213).

At this time, the memory controller 107 sequentially reads the image data D₁ in the vertical direction over the lines for each pixel with a pixel positioned on the lower left corner of the image being set as a reading start pixel. When pixels positioned at the upper end of the image are read, next, pixels are read in the vertical direction with a pixel positioned on the right side neighboring to the pixel positioned at the reading start position of the vertical direction being set as a reading start pixel. This operation is repeated until the reading of a pixel positioned on the upper right corner of the image is completed.

In other words, the memory controller 107 sequentially reads the image data D₁ from the memory Y₁ for each line in the vertical direction from the left end toward the right end of the image for each pixel in the line direction being set as the vertical direction from the lower end toward the upper end of the image.

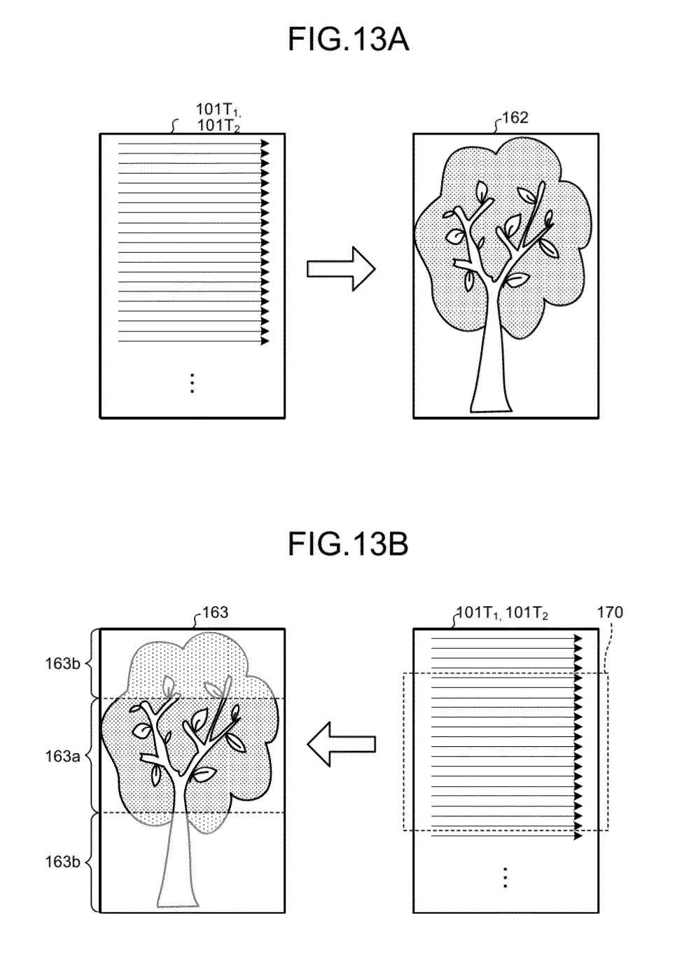

The memory controller 107 sequentially writes the pixels of the image data D₁ read from the memory Y₁ in this way, as illustrated on the left side in FIG. 13A, into the memory T₁ toward the line direction for each pixel (timing WD₁ illustrated in Chart 214). In other words, for example, every time when one pixel is read from the memory Y₁, the memory controller 107 writes one pixel that has been read into the memory T₁.

On the right side in FIG. 13A, the image 162 according to the image data D₁ written into the memory T₁ in this way is illustrated. The image data D₁ is written into the memory T₁ with a size of horizontal 1080 pixels×vertical 1920 pixels (lines) and is the image 162 acquired by rotating the input image 160 by 90° in the clockwise direction and interchanging the horizontal direction and the vertical direction.

The memory controller 107 designates an address of the cut out area that is designated by the correction control unit 108 to the memory T₁ and reads image data of the area designated as the cut out area from the memory T₁. The timing of this reading process, as represented by timing RD₁ in Chart 214, is delayed from the timing at which the image data D₁ is input to the memory controller 107 by two vertical synchronization signals VD.

The projector device 1 according to this embodiment, as described above, moves the projection position of the projection image by rotating the drum unit 10 so as to change the projection angle θ according to the projection lens 12 and designates a reading position for image data in accordance with the projection angle θ. For example, the image data D₁ is input to the memory controller 107 at the timing of the projection angle θ₁. The projection angle θ at the timing when an image according to the image data D₁ is actually projected may be changed from the projection angle θ₁ to a projection angle θ₃ different from the projection angle θ₁.

Accordingly, the cut out area at the time of reading the image data D₁ from the memory T₁ is read from a range that is larger than the area of image data corresponding to the projected image in consideration of a change in the projection angle θ.

The description will be described more specifically with reference to FIG. 13B. The left side in FIG. 13B illustrates an image 163 according to the image data D₁ stored in the memory T₁. In this image 163, an area that is actually projected is represented as a projection area 163a, and the other area 163b is represented as a non-projection area. In this case, the correction control unit 108 designates the cut out area 170 that is larger than the area of the image data corresponding to the image of the projection area 163 by at least the number of lines corresponding to a change of a case where the projection angle θ according to the projection lens 12 maximally changes during a period of two vertical synchronization signals VD for the memory T₁ (see the right side in FIG. 13B).

The memory controller 107 reads the image data from this cut out area 170 at the timing of a next vertical synchronization signal VD after the vertical synchronization signal VD for writing the image data D₁ into the memory T₁. In this way, at the timing of the projection angle θ₃, the image data to be projected is read from the memory T₁, is supplied to the display element 114 through the image processing unit 102 of a later stage, and is projected from the projection lens 12.

At the timing of the next vertical synchronization signal VD after the vertical synchronization signal VD for which the image data D₁ is input, the image data D₂ is input to the memory controller 107. At this timing, the image data D₁ is written into the memory Y₁. Accordingly, the memory controller 107 writes the image data D₂ into the memory Y₂ (timing WD₂ illustrated in Chart 215). The sequence of writing the image data D₂ into the memory Y₂ at this time is similar to the sequence of writing the image data D₁ described above into the memory Y₁, and the sequence for the image is similar to that described above (see FIG. 12B).

In other words, the memory controller 107 sequentially reads the image data D₂ in the vertical direction over the lines for each pixel up to the pixel positioned at the upper end of the image with a pixel positioned on the lower left corner of the image being set as a reading start pixel, and next, pixels are read in the vertical direction with a pixel positioned on the right side neighboring to the pixel positioned at the reading start position of the vertical direction being set as a reading start pixel (timing RD₂ illustrated in Chart 215). This operation is repeated until the reading of a pixel positioned on the upper right corner of the image is completed. The memory controller 107 sequentially writes (timing WD₂ represented in Chart 216) the pixel of the image data D₂ read from the memory Y₂ in this way into the memory T₂ toward the line direction for each pixel (see the left side in FIG. 13A).

The memory controller 107 designates an address of the cut out area that is designated by the correction control unit 108 to the memory T₂ and reads image data of the area designated as the cut out area from the memory T₂ at timing RD₂ represented in Chart 216. At this time, as described above, the correction control unit 108 designates an area lager than the area of the image data corresponding to the projected image as the cut out area 170 in consideration of a change in the projection angle θ for the memory T₂ (see the right side in FIG. 13B).

The memory controller 107 reads the image data from this cut out area 170 at the timing of a next vertical synchronization signal VD after the vertical synchronization signal VD for writing the image data D₂ into the memory T₂. In this way, the image data of the cut out area 170 of the image data D₂ input to the memory controller 107 at the timing of the projection angle θ₂ is read from the memory 12 at the timing of the projection angle θ₄, is supplied to the display element 114 through the image processing unit 102 of a later stage, and is projected from the projection lens 12.

Thereafter, similarly, for the image data D₃, D₄, D₅, . . . , the process is sequentially performed using a set of the memories Y₁ and T₁ and a set of the memories Y₂ and T₂ in an alternate manner.

As described above, according to this embodiment, in the image memory 101, an area of the memories Y₁ and Y₂ used for writing and reading image data with the size of horizontal 1920 pixels×vertical 1080 pixels (lines) and an area of the memories T₁ and T₂ used for writing and reading image data with the size of horizontal 1080 pixels×vertical 1920 pixels (lines) are arranged. The reason for this is that, generally, a dynamic random access memory (DRAM) used in an image memory has an access speed for the vertical direction that is lower than an access speed for the horizontal direction. In a case where another memory, which is easily randomly accessible, having access speeds of the same level for the horizontal direction and the vertical direction is used, a configuration may be employed in which a memory having a capacity corresponding to the image data is used in both the cases.

Geometric Distortion Correction

Next, the geometric distortion correction for the image data that is performed by the projector device 1 according to this embodiment will be described.

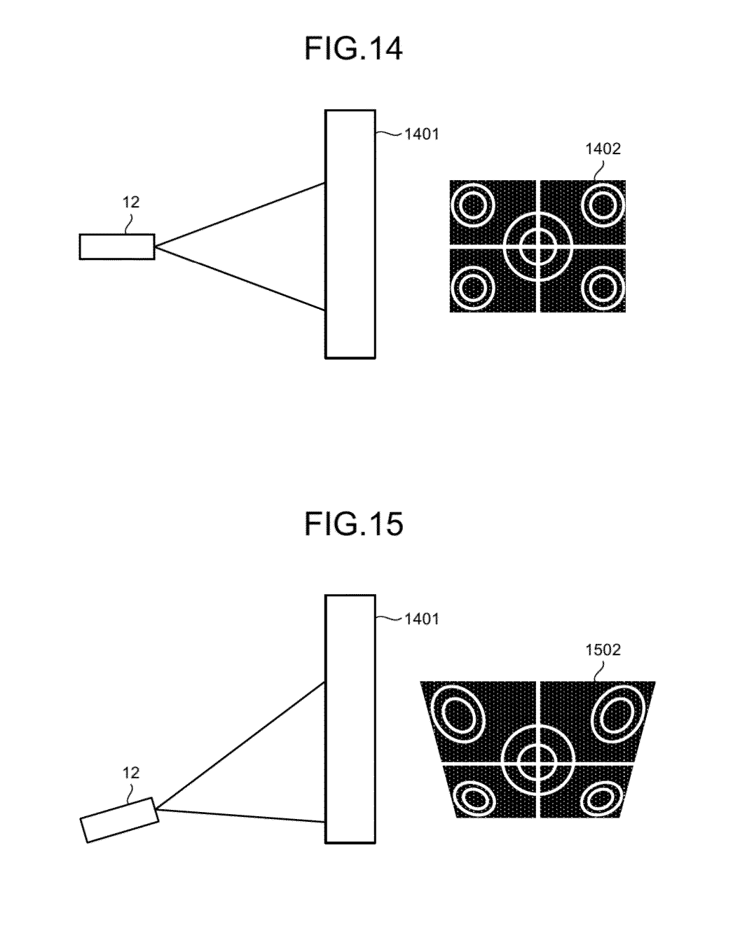

FIGS. 14 and 15 are diagrams that illustrate the relation between the projection direction of the projection lens 12 of the projector device 1 for a screen 1401 and the projection image projected onto the screen 1401 that is the projection face. As illustrated in FIG. 14, in a case where the projection angle is 0°, and the optical axis of the projection lens 12 is perpendicular to the screen 1401, a projection image 1402 has a rectangular shape that is the same as the image data projected from the projector device 1, and a distortion does not occur in the projection image 1402.

However, as illustrated in FIG. 15, in a case where the image data is projected in an inclined state with respect to the screen 1401, the projection image 1502 to be a rectangular shape is distorted to be in a trapezoidal shape, in other words, a so-called trapezoidal distortion occurs.

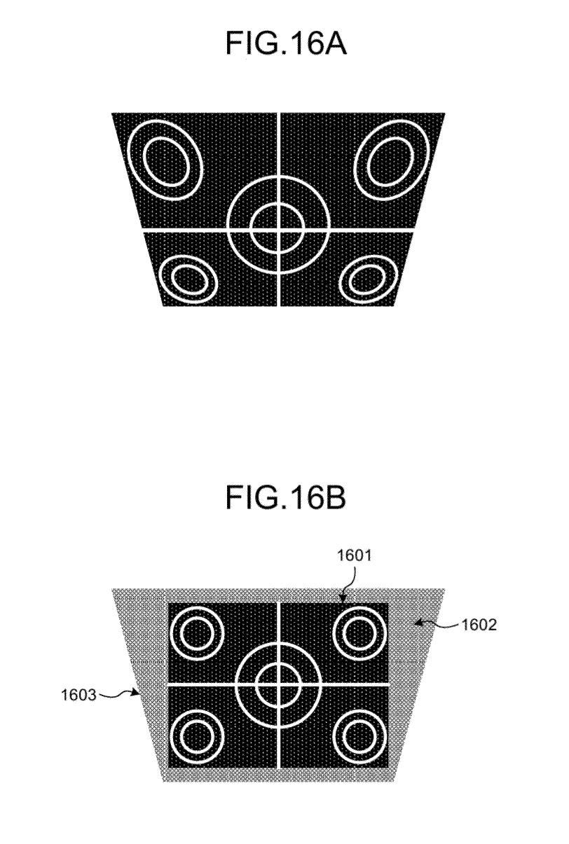

For this reason, conventionally, by performing a geometric distortion correction such as a trapezoidal distortion correction (keystone correction) transforming image data to be projected into a trapezoidal shape in a direction opposite to a trapezoidal shape generated in a projection image on a projection face such as a screen, as illustrated in FIGS. 16A and 16B, a projection image having a rectangular shape without any distortion on the projection face is displayed on a non-projection face. FIG. 16A illustrates an example of a projection image before a geometric distortion correction is performed for the image data of the projection image. FIG. 16B illustrates an example of a projection image after a geometric distortion correction is performed for the image data of the projection image illustrated in FIG. 16A.

However, in the conventional trapezoidal distortion correction (keystone correction), as illustrated in FIG. 16B, in order not to perform display of a peripheral area 1602 of a corrected projection image 1601, in other words, display of the area 1602 of a difference between an area 1603 of the projection image of a case where a correction is not performed and the area 1601 of the projection image after the correction, image data corresponding to black is input to the display device, or the display device is controlled so as not to drive the display device. Accordingly, the pixel area of the display device is not effectively used, but the brightness of the actual projection area is caused to be lowered.

Recently, in accordance with wide use of high-resolution digital cameras and the like, the resolution of a video content is improved, and there are cases where the resolution of the video content is higher than the resolution of the display device. For example, in a projector device supporting up to the full HD of 1920 pixels×1080 pixels as an input image for a display device having resolution of 1280 pixels×720 pixels, the input image is scaled in a former stage of the display device, and accordingly, the resolution is matched for enabling the whole input image to be displayed on the display device.

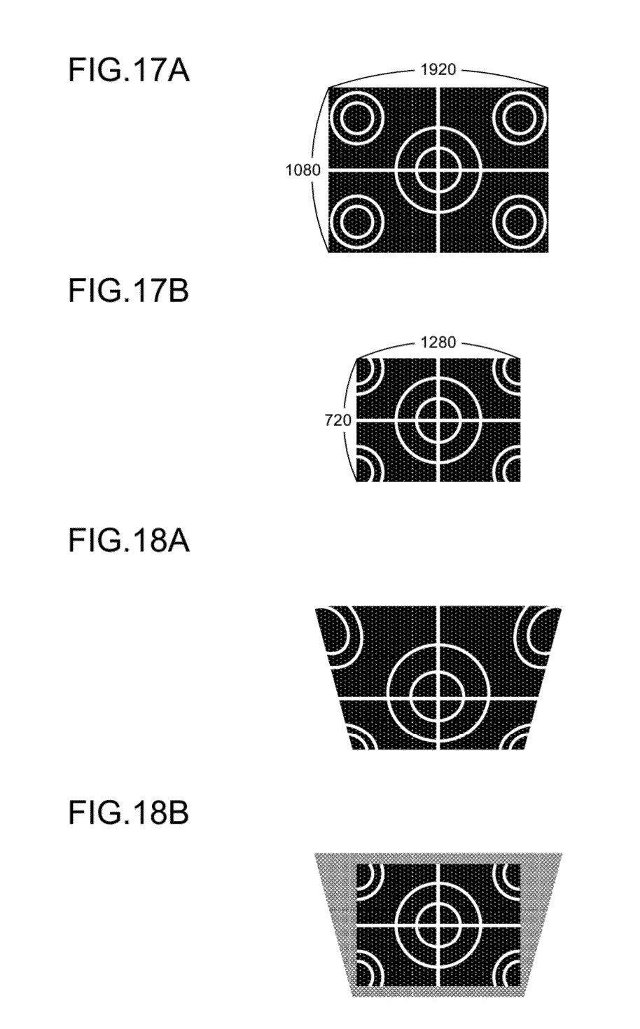

On the other hand, instead of performing such a scaling process, as illustrated in FIGS. 17A and 17B, an image of a partial area of input image data may be cut out and displayed on the display device. For example, from input image data having 1920 pixels×1080 pixels illustrated in FIG. 17A, as illustrated in FIG. 17B, an image of an area of 1280 pixels×720 pixels corresponding to the resolution of an output device is cut out and is displayed on the display device. Even in such a case, when the projection lens is inclined, as illustrated in FIG. 18A, a trapezoidal distortion occurs in the projection image. Thus, when the trapezoidal distortion correction (keystone correction) is performed, as illustrated in FIG. 18B, in order not to perform display of a differential area between the area of the projection image of a case where any correction is not performed and the area of the projection image after the correction, image data corresponding to black is input to the display device, or the display device is controlled so as not to be driven. Accordingly, a state is formed in which the pixel area of the display device is not effectively used. However, in such a case, as illustrated in FIGS. 17A and 17B, the projection image that is output is a part of the input image data.

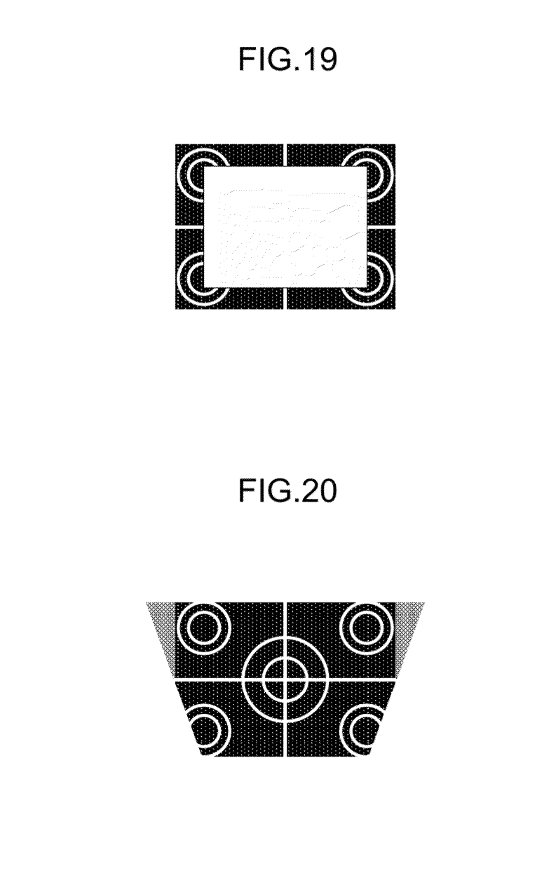

For this reason, according to the projector device 1 of this embodiment, as illustrated in FIG. 19, an image of the unused area remaining after being originally cut out from the input image data is used for the peripheral area 1602 of the image data after the correction described above, and, for example, as illustrated in FIG. 20, all the input image data is cut out, and the projection image is displayed such that the center of the projection image in the vertical direction coincides with that of the projection image for which the geometric distortion correction has not been performed, and the amount of information lacking in the peripheral area 1602 is supplemented. In this way, according to this embodiment, by effectively utilizing the image of the unused area, the effective use of the displayable area is realized. By comparing FIG. 20 with FIG. 18B, it can be understood that the area of the peripheral area is decreased in FIG. 20, and more information can be represented (in other words, the pixel area of the display device is effectively used). Hereinafter, for details of such a geometric distortion correction, first, the calculation of correction coefficients used for performing the geometric distortion correction and next, a method of supplementing the amount of information will be described.

The correction control unit 108 of the geometric distortion correction unit 100, as described above, calculates a first correction coefficient and a second correction coefficient based on the projection angle and the view angle. Here, the first correction coefficient is a correction coefficient for performing a correction of the image data in the horizontal direction, and the second correction coefficient is a correction coefficient for performing a correction of the image data in the vertical direction. The correction control unit 108 may be configured to calculate the second correction coefficient for each line configuring the image data (cut out image data) of the cut out range.

In addition, the correction control unit 108, for each line from the upper side to the lower side of the image data of the cut out range, calculates a linear reduction rate for each line based on the first correction coefficient.

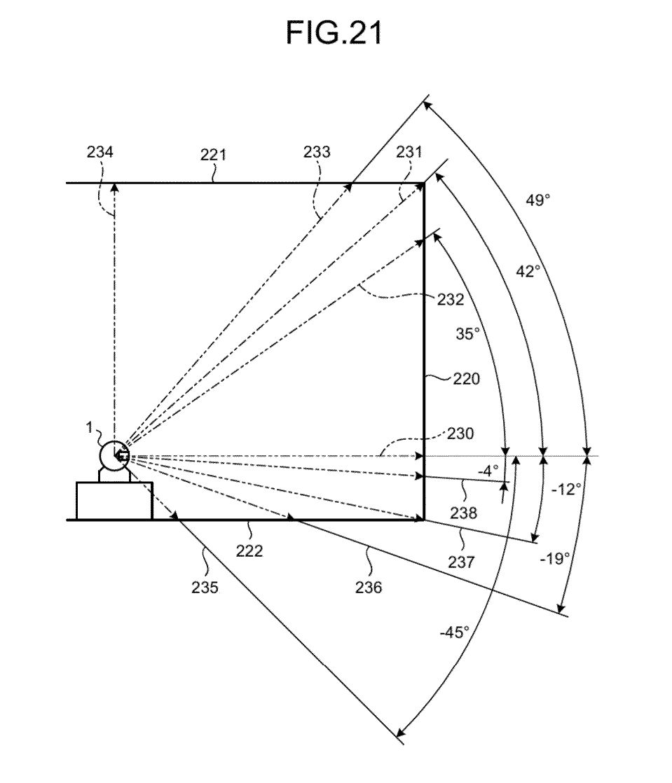

The relation between the projection angle and the correction coefficient and the correction coefficients and a correction amount for a trapezoidal distortion calculated based on the projection angle will be described in detail. FIG. 21 is a diagram that illustrates major projection directions and projection angles θ of the projection face according to the first embodiment.

Here, the projection angle θ is an inclination angle of the optical axis of projection light emitted from the projection lens 12 with respect to the horizontal direction. Hereinafter, an inclination angle of a case where the optical axis of the projection light is in the horizontal direction is set as 0°, a case where the drum unit 10 including the projection lens 12 is rotated to the upper side, in other words, the elevation angle side will be defined as positive, and a case where the drum unit 10 is rotated to the lower side, in other words, the depression angle side will be defined as negative. In such a case, a housed state in which the optical axis of the projection lens 12 faces a floor face 222 disposed right below corresponds to a projection angle (−90°), and a horizontal state in which the projection direction faces the front side of a wall face 220 corresponds to a projection angle (0°), and a state in which the projection direction faces a ceiling 221 disposed right above corresponds to a projection angle (+90°).

A projection direction 231 is a direction of a boundary between the wall face 220 and the ceiling 221 that are two projection faces adjacent to each other. A projection direction 232 is, the projection direction of the projection lens 12 in a case where an upper side, which corresponds to a first side, of one pair of sides disposed in a direction perpendicular to the vertical direction that is the moving direction of a projection image approximately coincides with the boundary in the projection image on the wall face 220.

A projection direction 233 is the projection direction of the projection lens 12 in a case where a lower side, which corresponds to a second side, of the above-described one pair of sides of the projection image of the ceiling 221 approximately coincides with the boundary. A projection direction 234 is the direction of the ceiling 221 right above the projector device 1 and corresponds to a state in which the optical axis of the projection lens 12 and the ceiling 221 cross each other at right angles. The projection angle at this time is 90°.

In the example illustrated in FIG. 21, the projection angle θ in the case of the projection direction 230 is 0°, the projection angle in the case of the projection direction 232 is 35°, the projection angle θ in the case of the projection direction 231 is 42°, and the projection angle θ in the case of the projection direction 233 is 49°.

A projection direction 235 is a direction in which projection is started by the projector device 1 that is acquired by rotating the projection lens from a state in which the projection lens is positioned toward the right below side (−90°), and the projection angle θ at this time is −45°. A projection direction 236 is the projection direction of the projection lens in a case where an upper side, which corresponds to a first side, of one pair of sides disposed in a direction perpendicular to the moving direction of a projection image approximately coincides with a boundary between the floor face 222 and the wall face 220 in the projection image on the floor face 222. The projection angle θ at this time will be referred to as a second boundary start angle, and the second boundary start angle is −19°.

A projection direction 237 is a direction of a boundary between the floor face 222 and the wall face 220 that are two projection faces adjacent to each other. The projection angle θ at this time will be referred to as a second boundary angle, and the second boundary angle is −12°.

A projection direction 238 is the projection direction of the projection lens in a case where a lower side, which corresponds to a second face, of the above-described one pair of sides of the projection image on the wall face 220 approximately coincides with a boundary between the floor face 222 and the wall face 220. The projection angle θ at this time will be referred to as a second boundary end angle, and the second boundary end angle is −4°.

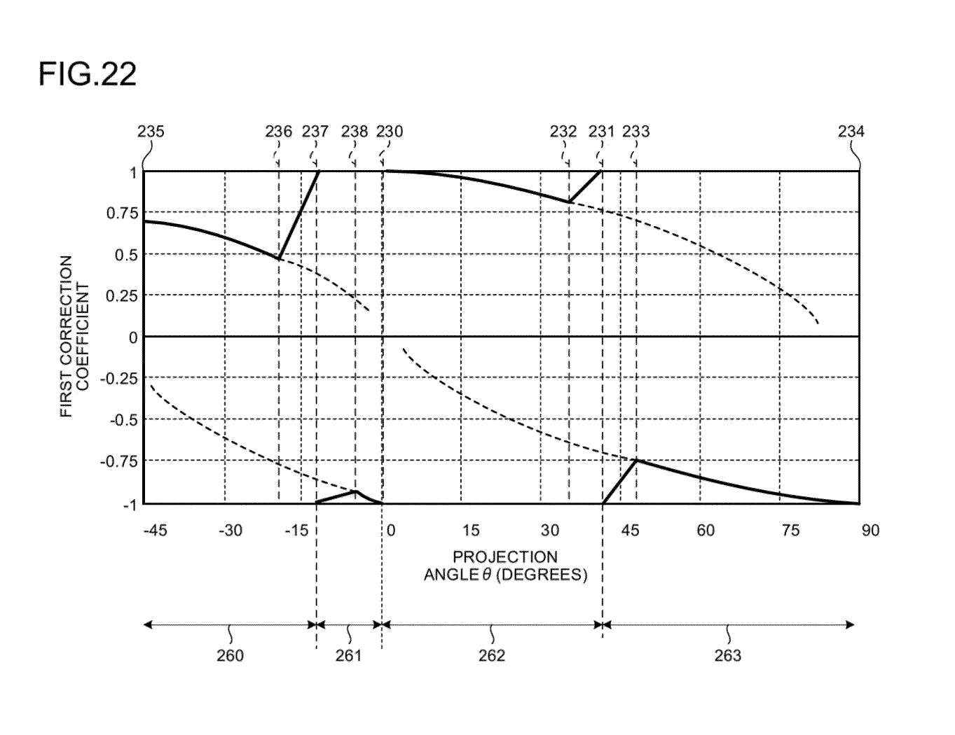

Hereinafter, an example of the geometric distortion correction (the trapezoidal distortion correction will be used as an example) will be described. FIG. 22 is a graph that illustrates a relation between the projection angle and the correction coefficient according to the first embodiment. In FIG. 22, the horizontal axis represents the projection angle θ, and the vertical axis represents the first correction coefficient. The first correction coefficient takes a positive value or a negative value. In a case where the first correction coefficient is positive, it represents a correction direction for compressing the length of the upper side of the trapezoid of the image data. On the other hand, in a case where the first correction coefficient is negative, it represents a correction direction for compressing the length of the lower side of the trapezoid of the image data. In addition, as described above, in a case where the first correction coefficient is “1” or “−1”, the correction amount for the trapezoidal distortion is zero, whereby the trapezoidal distortion correction is completely canceled.

In FIG. 22, the projection directions 235, 236, 237, 238, 230, 232, 231, 233, and 234 illustrated in FIG. 21 are illustrated in association with projection angles thereof. As illustrated in FIG. 22, in a range 260 from a projection angle (−45°) for the projection direction 235 to a projection angle (−12°) for the projection direction 237, the projection lens projects the floor face 222.

In addition, as illustrated in FIG. 22, in a range 261 from a projection angle (−12°) for the projection direction 237 to a projection angle (0°) for the projection direction 230, the projection lens projects the wall face 220 downward. Furthermore, as illustrated in FIG. 22, in a range 262 from a projection angle (0°) for the projection direction 230 to a projection angle (42°) for the projection direction 231, the projection lens projects the wall face 220 upward.

In addition, as illustrated in FIG. 22, in a range 263 from a projection angle (42°) for the projection direction 231 to a projection angle (90°) for the projection direction 234, the projection lens projects the ceiling 221.

The correction control unit 108 calculates a trapezoidal distortion correction amount based on a correction coefficient according to each projection angle θ denoted by a solid line in FIG. 22 and performs a trapezoidal distortion correction for the image data based on the calculated correction amount. In other words, the correction control unit 108 calculates a first correction coefficient corresponding to the projection angle output from the rotation control unit 104. In addition, the correction control unit 108, based on the projection angle θ, determines whether the projection direction of the projection lens 12 is the projection direction that is an upward projection direction with respect to the wall face 220, the projection direction toward the face of the ceiling 221, the projection direction that is a downward direction for the wall face 220, or the projection direction toward the floor face 222 and derives a correction direction of the trapezoidal distortion correction for the image data in accordance with the projection direction.

Here, as illustrated in FIG. 22, between a projection angle (−45°) at the time of the projection direction 235 and the second boundary start angle (−19°) that is the projection angle θ at the time of the projection direction 236 and between a projection angle (0°) at the time of the projection direction 230 and the first boundary start angle (35°) that is the projection angle at the time of the projection direction 232, the correction coefficient is positive and gradually decreases, and the correction amount for the trapezoidal distortion gradually increases. Here, the correction coefficient or the correction amount therebetween is used for maintaining the shape of the projection image projected onto the projection face to be a rectangle.

On the other hand, as illustrated in FIG. 22, between the second boundary start angle (−19°) that is the projection angle θ at the time of the projection direction 236 and the second boundary angle (−12°) that is the projection angle θ at the time of the projection direction 237 and between the first boundary start angle (35°) that is the projection angle θ of the projection direction 232 and the first boundary angle (42°) that is the projection angle θ at the time of the projection direction 231, the correction coefficient is positive and gradually increases so as to decrease a difference from “1” and is in a direction (a direction for canceling the trapezoidal distortion correction) for weakening the degree of the trapezoidal distortion correction. In the projector device 1 according to this embodiment, as described above, the correction coefficient is positive and gradually increases, and the correction amount for the trapezoidal distortion gradually decreases. Here, this increase may not be a gradual linear increase but may be an exponential increase or a geometric increase as long as the increase is a continuous gradual increase therebetween.

In addition, as illustrated in FIG. 22, between the second boundary angle (−12°) that is the projection angle θ at the time of the projection direction 237 and the second boundary end angle (−4°) that is the projection angle θ at the time of the projection direction 238 and between the first boundary angle (42°) that is the projection angle θ at the time of the projection direction 231 and the first boundary end angle (49°) that is the projection angle θ at the time of the projection direction 233, the correction coefficient is negative and gradually decreases, and the correction amount for the trapezoidal distortion gradually increases. In the projector device 1 according to this embodiment, as described above, the correction coefficient is negative and gradually increases, and the correction amount for the trapezoidal distortion gradually increases. Here, this increase may not be a gradual linear increase but may be an exponential increase or a geometric increase as long as the increase is a continuous gradual increase therebetween.

Here, as illustrated in FIG. 22, between the second boundary end angle (−4°) that is the projection angle θ at the time of the projection direction 238 and a projection angle (0°) at the time of the projection direction 230 and between the first boundary end angle (49°) that is the projection angle θ of the projection direction 233 and a projection angle (90°) at the time of the projection direction 234, the correction coefficient is negative and gradually decreases, and the correction amount for the trapezoidal distortion gradually decreases. Here, the correction coefficient or the correction amount therebetween is used for maintaining the shape of the projection image projected onto the projection face to be a rectangle.

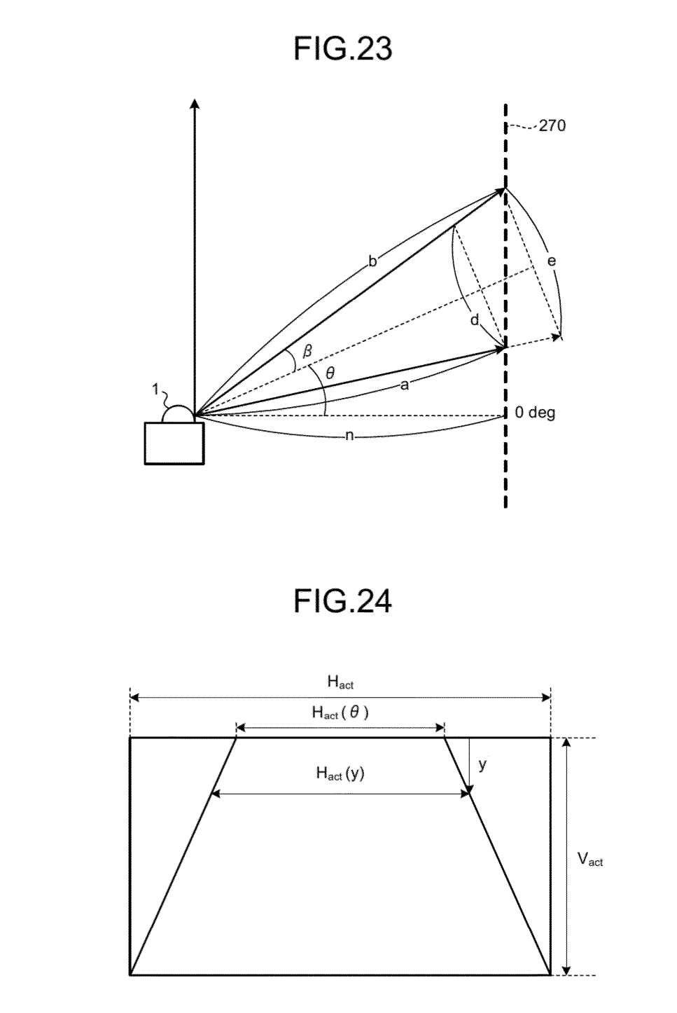

Here, a technique for calculating the correction coefficient will be described. FIG. 23 is a diagram that illustrates the calculation of the first correction coefficient. The first correction coefficient is the reciprocal of a ratio between the upper side and the lower side of a projection image that is projected to the projection medium so as to be displayed thereon and is the same as d/e that is a ratio between lengths d and e in FIG. 23. Accordingly, in the trapezoidal distortion correction, the upper side or the lower side of the image data is reduced by d/e times.

Here, as illustrated in FIG. 23, when a ratio of a projection distance a from the projector device 1 to a lower side of the projection image that is projected to the projection medium so as to be displayed thereon to a distance b from the projector device 1 to an upper side of the projection image is represented as a/b, d/e is represented in the following Equation (9).

$$\frac{d}{e} = \frac{a}{b} \qquad ( 9 )$$

Then, in FIG. 23, when an angle θ is the projection angle, an angle β is a half of the view angle α, and a value n is a projection distance from the projector device 1 to the projection face 270 in the horizontal direction, the following Equation (10) is formed. Here, 0°≦θ<90°, and 7.83°≦β≦11.52°.

n=b cos(θ+β)=a cos(θ−β) (10)

By transforming Equation (10), Equation (11) is acquired. Accordingly, based on Equation (11), the correction coefficient is determined based on the angle β that is a half of the view angle α and the projection angle θ.

$$\frac{a}{b} = \frac{cos ( θ + β )}{cos ( θ - β )} = k ( θ , β ) \qquad ( 11 )$$

Based on this Equation (11), in a case where the projection angle θ is 0°, in other words, in a case where the projection image is projected in a direction horizontal to the projection face 270, the first correction coefficient is “1”, and, in such a case, the trapezoidal distortion correction amount is zero.

In addition, based on Equation (11), the first correction coefficient decreases as the projection angle θ increases, and the trapezoidal distortion correction amount increases according to the value of the first correction coefficient. Accordingly, the trapezoidal distortion of the projection image that becomes remarkable according to an increase in the projection angle θ can be appropriately corrected.

Furthermore, in a case where the projection image is projected onto the ceiling that is disposed right above and is perpendicular to the projection face 270, the correction direction of the trapezoidal distortion correction changes, and accordingly, the correction coefficient is b/a. In addition, as described above, the sign of the correction coefficient is negative.

In this embodiment, the correction control unit 108 calculates the correction coefficient based on Equation (11) when the projection angle θ is between the projection angle (−45°) at the time of the projection direction 235 and the second boundary start angle (−19°) that is the projection angle θ at the time of the projection direction 236, between the projection angle (0°) at the time of the projection direction 230 and the first boundary start angle (35°) that is the projection angle at the time of the projection direction 232, between the second boundary end angle (−4°) that is the projection angle θ at the time of the projection direction 238 and the projection angle (0°) at the time of the projection direction 230, or between the first boundary end angle (49°) that is the projection angle θ of the projection direction 233 and the projection angle (90°) at the time of the projection direction 234, described above.

On the other hand, the correction control unit 108 calculates the correction coefficient in a direction for lowering the degree of the correction without using Equation (11) when the projection angle θ is between the second boundary start angle (−19°) that is the projection angle θ at the time of the projection direction 236 and the second boundary angle (−12°) that is the projection angle θ at the time of the projection direction 237 or between the first boundary start angle (35°) that is the projection angle θ at the time of the projection direction 232 and the first boundary angle (42°) that is the projection angle θ at the time of the projection direction 231.

In addition, the correction control unit 108 calculates the correction coefficient in a direction for raising the degree of the correction without using Equation (11) when the projection angle θ is between the second boundary angle (−12°) that is the projection angle θ at the time of the projection direction 237 and the second boundary end angle (−4°) that is the projection angle θ at the time of the projection direction 238 or between the first boundary angle (42°) that is the projection angle θ at the time of the projection direction 231 and the first boundary end angle (49°) that is the projection angle θ at the time of the projection direction 233.

The calculation of the first correction coefficient is not limited to that described above, and the correction control unit 108 may be configured to calculate the first correction coefficient using Equation (11) for all the projection angles θ.

The correction control unit 108 multiplies the length H_{act} of the line of the upper side of the image data by a correction coefficient k(θ, β) represented in Equation (11) and calculates the length H_{act}(θ) of the line of the upper side after the correction using the following Equation (12) for the correction.

H_{act}(θ)=k(θ,β)×H_{act} (12)

The correction control unit 108, in addition to the length of the upper side of the image data, calculates a reduction rate of the length of each line in a range from the line of the upper side to the line of the lower side. FIG. 24 is a diagram that illustrates the calculation of lengths of lines from the upper side to the lower side.

As illustrated in FIG. 24, the correction control unit 108 calculates and corrects the length H_{act}(y) of each line from the upper side to the lower side of the image data so as to be linear using the following Equation (13). Here, V_{act} is the height of the image data, in other words, the number of lines, and Equation (13) is an equation for calculating the length H_{act}(y) of the line at a position y from the upper side. In Equation (13), a portion of braces { } is a reduction rate for each line, and, as illustrated in Equation (13), the reduction rate can be acquired depending on the projection angle θ and the view angle α (actually, the angle β that is a half of the view angle α).

$${H}_{act} ( y ) = \{ 1 - ( 1 - k ( θ , β ) ) \times \frac{{V}_{act} - y}{{V}_{act}} \} \times {H}_{act} \qquad ( 13 )$$

Another method of calculating the first correction coefficient will now be described. The first correction coefficient may be calculated from a ratio between the length of the side of the projection image at the projection angle 0° and the length of the side of the projection image at the projection angle θ. In such a case, the length H_{act}(y) of each line from the upper side to the lower side of the image data can be represented as in Equation (14).

$${H}_{act} ( y ) = cos ( ( θ + β ) - 2 β \times \frac{y}{{V}_{act}} ) \times {H}_{act} \qquad ( 14 )$$

In the trapezoidal distortion correction using the first correction coefficient according to this calculation method, an image having the same size as the projection image of the projection angle 0° can be projected regardless of the projection angle θ.

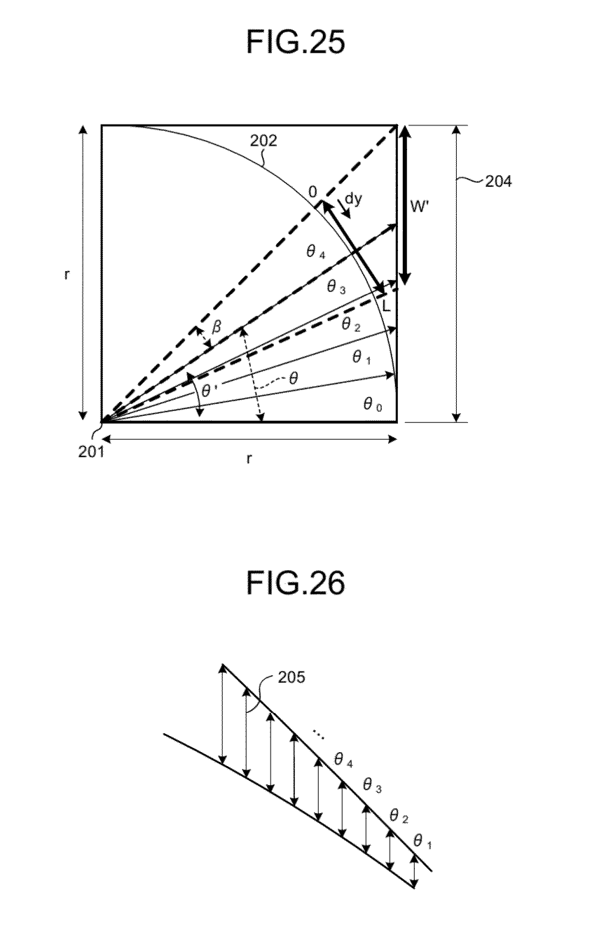

FIGS. 25 and 26 are diagrams that illustrate the calculation of the second correction coefficient. The method of designating a cut out area using Equations (3) and (4) described above is based on a cylindrical model in which the projection face 130, for which projection is performed by the projection lens 12, is assumed to be a cylinder having the rotation shaft 36 of the drum unit 10 as its center. However, actually, the projection face 130 is frequently considered to be a perpendicular face (hereinafter, simply referred to as a “perpendicular face”) forming an angle of 90° with respect to the projection angle θ=0°. In a case where image data of the same number of lines is cut out from the image data 140 and is projected to the perpendicular face, as the projection angle θ increases, an image projected to the perpendicular face grows in the vertical direction. Thus, the correction control unit 108 calculates the second correction coefficient as below, and a trapezoidal distortion correction for the image data is performed using the second correction coefficient by the memory controller 107.

As illustrated in FIG. 25, a case will be considered in which an image is projected from the projection lens 12 onto a projection face 204 that is disposed to be separate from a position 201, which is the position of the rotation shaft 36 of the drum unit 10, by a distance r.

In the cylindrical model described above, a projection image is projected with an arc 202 that has the position 201 as its center and has a radius r being the projection face. Each point on the arc 202 has the same distance from the position 201, and the center of the luminous fluxes of light projected from the projection lens 12 is a radius of a circle including the arc 202. Accordingly, even when the projection angle θ is increased from an angle θ₀ of 0° to an angle θ₁, an angle θ₂, . . . , the projection image is projected onto the projection face with the same size all the time.

On the other hand, in a case where an image is projected from the projection lens 12 onto the projection face 204 that is a perpendicular face, when the projection angle θ is increased from an angle θ₀ to an angle θ₁, an angle θ₂, . . . , a position on the projection face 204 to which the center of luminous fluxes of light emitted from the projection lens 12 is projected changes according to the characteristics of a tangent function as a function of the angle θ.

Accordingly, the projection image grows upwardly in accordance with a ratio M represented in the following Equation (15) as the projection angle θ increases.

$$M = \frac{180 \times tan θ}{θ \times π} \qquad ( 15 )$$

Here, when the angle θ is a projection angle, an angle β is a half of the view angle α, and a total number of lines of the display element 114 is a value L, a projection angle θ′ of a luminous ray projecting a line disposed at a perpendicular position dy on the display element 114 is calculated using Equation (16).

$${θ}^{′} = ( θ + β ) - 2 β \frac{d y}{L} \qquad ( 16 )$$

The height Lh(dy) of the line at the time of projecting the line disposed at the perpendicular position dy on the display element 114 onto the projection face 204 is calculated using Equation (17).

Lh(dy)=r(tan(θ+β−2β×(dy−1)/L)−tan(θ+β−2β×dy/L)) (17)

Accordingly, an enlargement rate M_{L}(dy) of the height Lh(dy) of the line at the time of projecting the line disposed at the perpendicular position dy on the display element 114 onto the projection face 204 with respect to the height of the line of the lower side (dy=L) is calculated using Equation (18).

$${M}_{L} ( dy ) = \frac{( tan ( θ + β - 2 β \times ( dy - 1 ) / L ) - tan ( θ + β - 2 β \times dy / L ) )}{( tan ( θ + β - 2 β \times ( L - 1 ) / L ) - tan ( θ + β - 2 β ) )} \qquad ( 18 )$$

The second correction coefficient is the reciprocal of the enlargement rate M_{L}(dy) and is calculated for each line disposed at the perpendicular position dy on the display element 114.

In addition, in a case where the view angle α or the projection angle θ is small, instead of calculating the second correction coefficient for each line disposed at the perpendicular position dy on the display element 114 using Equation (18), the second correction coefficient may be calculated by acquiring the enlargement rate M_{L}(1) of the height of the line of the upper side (dy=1) with respect to the height of the line of the lower side (dy=L) using Equation (19) and approximating the second correction coefficient through linear interpolation for an intermediate value.

$${M}_{L} ( dy ) = \frac{( tan ( θ + β ) - tan ( θ + β - 2 β / L ) )}{( tan ( θ + β - 2 β \times ( L - 1 ) / L ) - tan ( θ + β - 2 β ) )} \qquad ( 19 )$$

Another method of calculating the second correction coefficient will be described. The second correction coefficient may be calculated from a ratio between the height of the projection image of the projection angle 0° and the height of the projection image of the projection angle θ.

When the angle θ is the projection angle, and the angle β is a half of the view angle α, a value M₀ that is the ratio of the height of the projection image of the projection angle θ to the height of the projection image of the projection angle 0° can be calculated using the following Equation (20).

$${M}_{0} = \frac{180}{π α} \times \{ tan ( θ + β ) - tan ( θ - β ) \} \qquad ( 20 )$$

As the second correction coefficient, the reciprocal of the value M₀ may be used.

Here, when the angle θ is the projection angle, and the angle β is a half of the view angle α, the height W′ of the projection image of the projection angle θ is represented as in Equation (21).

W′=r×{tan(θ+β)−tan(θ−β)} (21)

The height of the projection image at a projection angle of 0° and the view angle α is approximated to a height L acquired by delimiting a tangential line at the projection angle θ of the arc 202 illustrated in FIG. 25 using lines emitted from the center of the circle with angles of +β and −β having the projection angle θ at the center thereof. The height L is represented as in Equation (22).

$$L = \frac{π r α}{180} \qquad ( 22 )$$

Based on Equations (21) and (22), a value M₀ that is the ratio of the height of the projection image of the projection angle θ to the height of the projection image of the projection angle 0° is represented as in Equation (23).

$${M}_{0} = \frac{180}{π α} \times \{ tan ( θ + β ) - tan ( θ - β ) \} \qquad ( 23 )$$

According to Equation (15) described above, for example, in the case of the projection angle θ=45°, the projection image grows at the ratio of about 1.27 times. In addition, in a case where the projection face 204 is much higher than the length of the radius r, and projection at the projection angle θ=60° can be performed, in the case of the projection angle θ=60°, the projection image grows at the ratio of about 1.65 times.

In addition, as illustrated in FIG. 26 as an example, a line gap 205 in the projection image on the projection face 204 is widened as the projection angle θ increases. In this case, the line gap 205 is widened based on Equation (15) described above in accordance with the position on the projection face 204 within one projection image.

Thus, the correction control unit 108, in accordance with the projection angle θ of the projection lens 12, performs a geometric distortion correction by performing a reduction process for image data to be projected by calculating the reciprocal of the ratio M_{L}(dy) represented in Equation (18) described above as the second correction coefficient and multiplying the height of the line by the second correction coefficient using the memory controller 107, thereby eliminating the vertical-direction distortion of the image data.

In the vertical-direction reduction process (geometric distortion correction process), image data is preferably larger than the image data cut out based on the cylindrical model. In other words, while the image data depends on the height of the projection face 204 that is a perpendicular face, in the case of the projection angle θ=22.5° and the view angle α=45°, the projection image grows at the ratio of about 1.27 times, and accordingly, the image data is reduced at the ratio of the reciprocal thereof that is about 1/1.27 times.

In addition, the correction control unit 108 acquires a cut out range of the image data based on the first correction coefficient, the second correction coefficient, and the reduction rate calculated as described above and outputs the acquired cut out range to the extended function control unit 109 and the memory controller 107.

For example, in a case where the view angle α is 10°, and the projection angle θ is 30°, the projection image is distorted to be in a trapezoidal shape, and the length of the upper side of the trapezoid is about 1.28 times of the length of the lower side. Accordingly, in order to correct the horizontal-direction distortion, the correction control unit 108 calculates the first correction coefficient as 1/1.28, reduces a first line of the upper side of the image data at 1/1.28 times, and sets reduction rates of lines to be linear such that the final line is scaled to the original size. In other words, the number of pixels for the first line of the output of the image data is reduced from 1280 pixels to 1000 pixels (1280/1.28=1000), whereby the trapezoidal distortion is corrected.

However, in this state, as described above, for the first line, image data of 280 pixels (1280−1000=280) is not projected, and the number of effective projection pixels decreases. Thus, in order to supplement the amount of information as illustrated in FIG. 20, the memory controller 107, for the first line, reads a signal of 1.28 times of the horizontal resolution of the image data from the image memory 101, and the correction control unit 108 determines a cut out range of the image data so as to perform this process for each line.

The extended function control unit 109 achieves the role of associating the image control unit 103 with the geometric distortion correction unit 100. In other words, in an area for which all the outputs of the image data is painted in black according to the geometric distortion correction in a conventional case, information of the image data is represented. For this reason, the extended function control unit 109, in accordance with the cut out range input from the correction control unit 108, sets the output resolution to be higher than the resolution of 1280 pixels×720 pixels at the time of outputting the image data in the output resolution control unit 1031. In the example described above, since the enlargement/reduction rate is one, the extended function control unit 109 sets the output resolution as 1920 pixels×1080 pixels.

In this way, the memory controller 1032 of the image control unit 103 stores the input image data in the image memory 101 with the resolution of 1920 pixels×1080 pixels. Accordingly, the image data in the cut out range can be cut out in the state in which, as illustrated in FIG. 20, the amount of information is supplemented from the memory controller 107 of the geometric distortion correction unit 100.

In addition, the memory controller 107 performs the geometric distortion correction as below by using the first correction coefficient, the reduction rate, and the second correction coefficient calculated as described above. In other words, the memory controller 107 multiplies the upper side of the image data of the cut out range by the first correction coefficient and multiplies each line of the upper side to the lower side of the image data of the cut out range by a reduction rate. In addition, the memory controller 107 generates lines corresponding to a display pixel number from the image data of the lines configuring the image data of the cut out range based on the second correction coefficient.

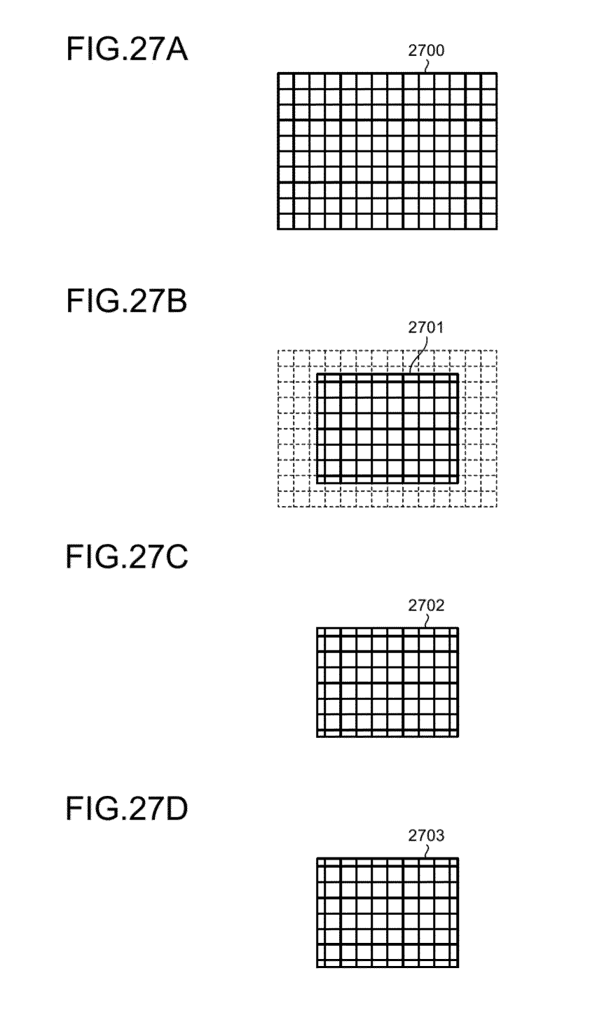

Next, an example of the cutting out of image data and the geometric distortion correction performed by the geometric distortion correction unit 100 according to this embodiment will be described with being compared with a conventional case. In FIG. 20 described above, an example has been described in which all the input image data is cut out, and the projection image is displayed such that the center of the projection image in the vertical direction coincides with the projection image for which the geometric distortion correction has not been performed. Hereinafter, with reference to FIGS. 27 to 30, an example will be described in which the input image data is cut out in accordance with the number of pixels of the display element 114, and the geometric distortion correction is performed with the cut out range also including the area of the geometric distortion that may occur in the projection image in accordance with the projection direction being set as the cut out image data.

FIGS. 27A to 27D are diagrams that illustrate examples of cutting out of image data, image data on the display element 114, and the projection image in a case where the projection angle is 0°. As illustrated in FIG. 27A, in a case where the projection angle is 0°, when image data 2700 of 1920 pixels×1080 pixels is input, the memory controller 107 cuts outs a range of 1280 pixels×720 pixels that is the resolution of the display element 114 from the image data 2700 (image data 2701 illustrated in FIG. 27B). For the convenience of description, a center portion is assumed to be cut out (hereinafter, the same). Then, the memory controller 107 does not perform a geometric distortion correction for the cut out image data 2701 (image data 2702 illustrated in FIG. 27C) but, as illustrated in FIG. 27D, projects the cut out image data onto the projection face as a projection image 2703.

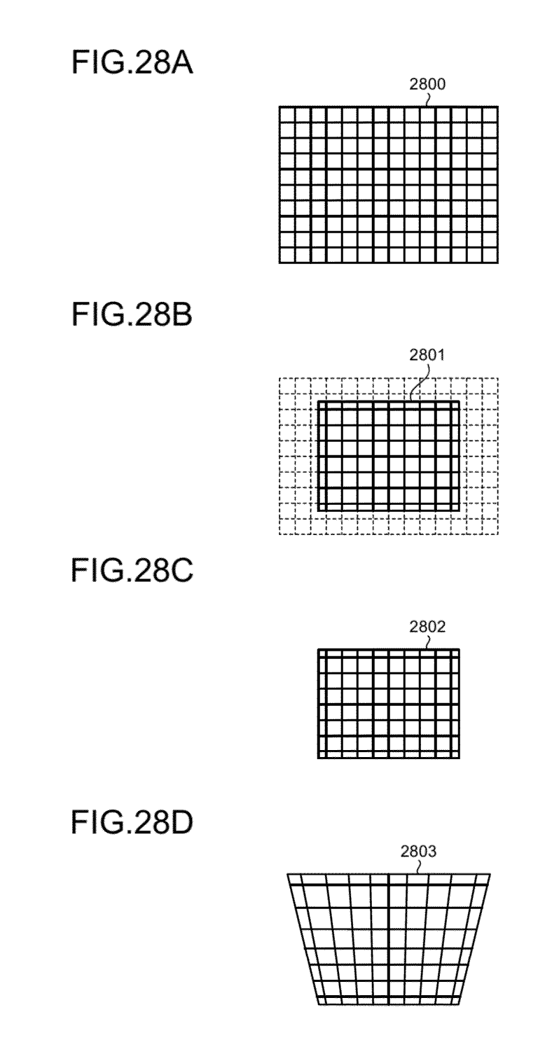

FIGS. 28A to 28D are diagrams that illustrate examples of cutting out of image data, image data on the display element 114, and a projection image in a case where the projection angle θ is greater than 0°, and a geometric distortion correction is not performed.

As illustrated in FIG. 28A, in a case where the projection angle θ is greater than 0°, when image data 2800 of 1920 pixels×1080 pixels is input, a range of 1280 pixels×720 pixels that is the resolution of the display element 114 is cut out from the image data 2800 (image data 2801 illustrated in FIG. 28B). Then, since the geometric distortion correction (trapezoidal distortion correction) is not performed (image data 2802 illustrated in FIG. 28C), as illustrated in FIG. 28D, a projection image 2803 in which a trapezoidal distortion has occurred is projected onto the projection face. In other words, in the horizontal direction, the projection image is distorted in a trapezoidal shape in accordance with the projection angle θ, and, in the vertical direction, a distance of the projection face is different in accordance with the projection angle θ, whereby a vertical distortion in which the height of the line increases in the upward vertical direction occurs.

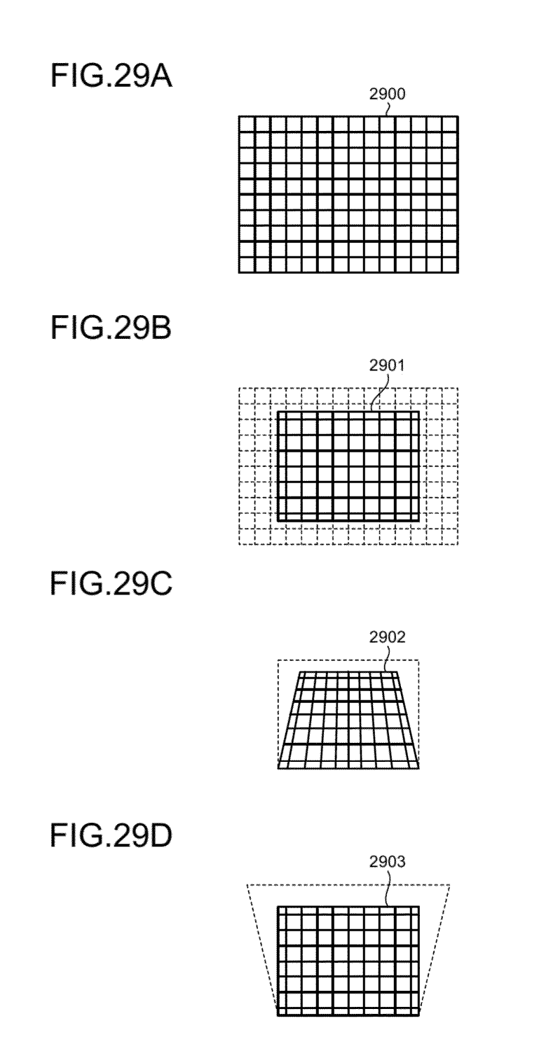

FIGS. 29A to 29D are diagrams that illustrate examples of cutting out of image data, image data on a display element 114, and a projection image in a case where the projection angle θ is greater than 0°, and a conventional trapezoidal distortion correction is performed.

As illustrated in FIG. 29A, in a case where the projection angle θ is greater than 0°, when image data 2900 of 1920 pixels×1080 pixels is input, a range of 1280 pixels×720 pixels that is the resolution of the display element 114 is cut out from the image data 2900 (image data 2901 illustrated in FIG. 29B). Then, for the image data 2901 of the cut out range, a conventional trapezoidal distortion correction is performed. More specifically, as illustrated in FIG. 29C, in the horizontal direction, the image data is corrected in a trapezoidal shape in accordance with the projection angle θ, and, in the vertical direction, a distortion correction in which the height of the line increases in the vertical downward direction is performed. Then, image data 2902 after the correction is projected onto the projection face, and, as illustrated in FIG. 29D, a projection image 2903 having a rectangular shape is displayed. In such a case, while the distortion is corrected in both the horizontal direction and the vertical direction for the projection image 2903, there are pixels not contributing to the display.

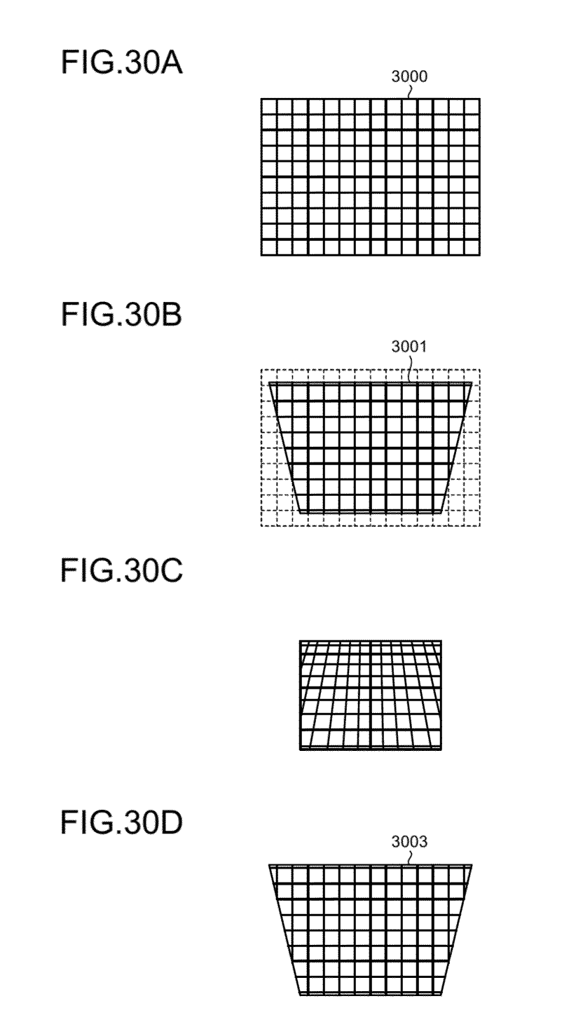

FIGS. 30A to 30D are diagrams that illustrate examples of cutting out of image data, image data on a display element 114, and a projection image in a case where the projection angle θ is greater than 0°, and the geometric distortion correction (trapezoidal distortion correction) according to this embodiment is performed.

As illustrated in FIG. 30A, in a case where the projection angle θ is greater than 0°, when image data 3000 of 1920 pixels×1080 pixels is input, the memory controller 107, as illustrated in FIG. 30B, from this image data 3000, cuts out image data 3001 of a range of an area of a trapezoidal shape of a cut out range according to the projection angle θ from the image memory 101. Here, as the cut out range, by the correction control unit 108, the horizontal lower side is calculated as 1280 pixels, and the horizontal upper side is calculated as a value acquired by multiplying 1280 pixels by the reciprocal of the first correction coefficient according to the projection angle, and, as the range in the vertical direction, a value acquired by multiplying the height of the input image data by the reciprocal of the second correction coefficient is calculated.

Then, the memory controller 107 performs the geometric distortion correction for the image data of the cut out range. More specifically, as illustrated in FIG. 30C, the memory controller 107, in the horizontal direction, corrects the image data in a trapezoidal shape according to the projection angle θ, and, in the vertical direction, performs a distortion correction in which the height of the line increases in the downward vertical direction. Here, as illustrated in FIG. 30B, since the memory controller 107 cuts out pixels corresponding to the area of the trapezoidal shape according to the projection angle θ, an image of 1280 pixels×720 pixels is expanded on the display element 114, and, as illustrated as a projection image 3003 in FIG. 30D, the cut out area is projected without being reduced.

As illustrated in the examples represented in FIGS. 30A to 30D, an image of the unused area that originally remains after the cutting out of the input image data is used for the area of the periphery of the image data after the geometric distortion correction (trapezoidal distortion correction), whereby the projection image is displayed, and the amount of information lacking in the area of the periphery in the horizontal direction and the vertical direction is supplemented. Accordingly, compared to the conventional technique illustrated in FIGS. 29A to 29D, the image of the conventionally unused area can be effectively used, whereby effective use of the displayable area after the geometric distortion correction (trapezoidal distortion correction) is realized.

Process of Projecting Image Data

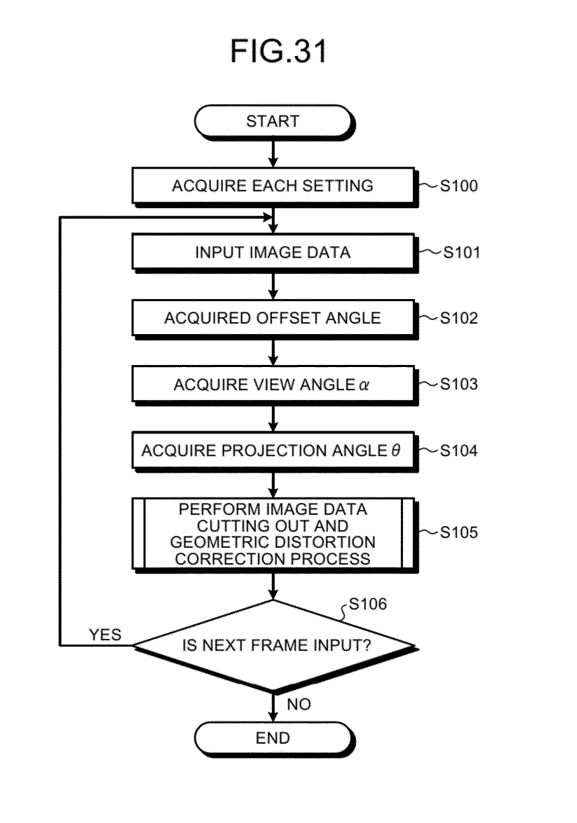

Next, the flow of the process performed when an image according to the image data is projected by the projector device 1 will be described. FIG. 31 is a flowchart that illustrates the sequence of an image projection process according to the first embodiment.

In step S100, in accordance with input of image data, various setting values relating to the projection of an image according to the image data are input to the projector device 1. The input various setting values, for example, are acquired by the input control unit 119 and the like. The various setting values acquired here, for example, includes a value representing whether or not the image according to the image data is rotated, in other words, whether or not the horizontal direction and the vertical direction of the image are interchanged, an enlargement rate of the image, and an offset angle θ_{ofst} at the time of projection. The various setting values may be input to the projector device 1 as data in accordance with the input of the image data to the projector device 1 or may be input by operating the operation unit 14.

In next step S101, image data corresponding to one frame is input to the projector device 1, and the input image data is acquired by the memory controller 1032. The acquired image data is written into the image memory 101.

In next step S102, the image control unit 103 acquires the offset angle θ_{ofst}. In next step S103, the correction control unit 108 acquires the view angle α from the view angle control unit 106. In addition, in next step S104, the correction control unit 108 acquires the projection angle θ of the projection lens 12 from the rotation control unit 104.

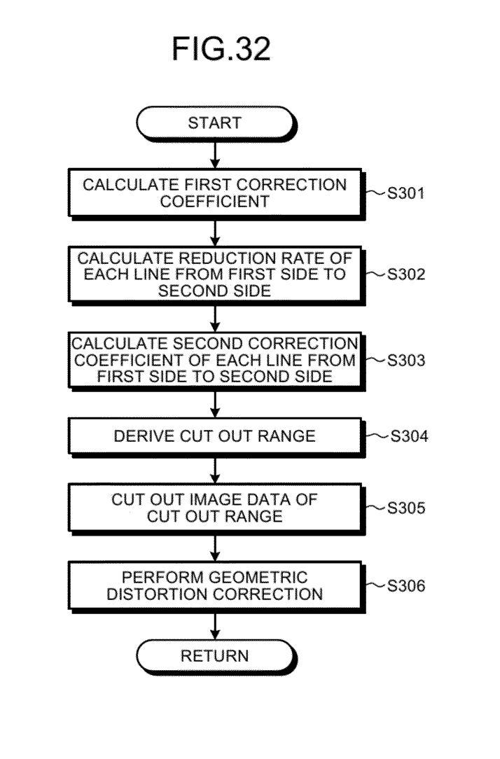

In next step S105, the image data cutting out and geometric distortion correction process are performed. Here, the image data cutting out and geometric distortion correction process will be described in detail. FIG. 32 is a flowchart that illustrates the sequence of the image data cutting out and geometric distortion correction process according to the first embodiment.

First, in step S301, the correction control unit 108 calculates the first correction coefficient using Equation (11). In next step S302, the correction control unit 108 calculates the reduction rate of each line from the upper side (first side) to the lower side (second side) of the image data using the equation represented inside the braces { } illustrated in Equation (13). In addition, in step S303, the correction control unit 108 acquires the second correction coefficient for each line as the reciprocal of the enlargement rate M_{L}(dy) calculated using Equation (18).

Then, next, in step S304, the correction control unit 108 acquires the cut out range based on the first correction coefficient and the second correction coefficient as described above.

Next, in step S305, the memory controller 107 cuts out image data of the cut out range from the image data stored in the image memory 101. Then, in step S306, the memory controller 107 performs the geometric distortion correction described above for the image data of the cut out range using the first correction coefficient, the second correction coefficient, and the reduction rate and ends the process.

Returning to FIG. 31, when the image data cutting out and geometric distortion correction process are completed in step S105, in step S106, the control unit 120 determines whether or not an input of image data of a next frame after the image data input in step S101 described above is present.

In a case where the input of the image data of the next frame is determined to be present, the control unit 120 returns the process to step S101 and performs the process of steps S101 to S105 described above for the image data of the next frame. In other words, the process of steps S101 to S105 is repeated in units of frames of the image data in accordance with a vertical synchronization signal VD of the image data. Accordingly, the projector device 1 can cause each process to follow a change in the projection angle θ in units of frames.

On the other hand, in step S106, in a case where the image data of the next frame is determined not to have been input, the control unit 120 stops the image projection operation in the projector device 1. For example, the control unit 120 controls the light source 111 so as to be turned off and issues a command for returning the posture of the drum unit 10 to be in the housed state to the rotation mechanism unit 105. Then, after the posture of the drum unit 10 is returned to be in the housed state, the control unit 120 stops the fan cooling the light source 111 and the like.

As above, according to this embodiment, in a case where the geometric distortion correction is performed for the image data, a projection image is displayed by using an image of the unused area originally remaining after the cutting out of the input image data for the area of the periphery of the image data after the geometric distortion correction, and the amount of information lacking in the area of the periphery in the horizontal direction and the vertical direction is supplemented. For this reason, according to this embodiment, compared to a conventional technology, by effectively using the image of the unused area, the geometric distortion correction is performed for the content of the projection image, and a high-quality projection image effectively using the displayable area can be acquired.

Particularly, in a case where, for example, an environment video such as the sky or the night sky is projected using the projector device 1 according to this embodiment, even in a case where the projection image is displayed in a trapezoidal shape, when the amount of information to be displayed is large, a realistic sensation can be more effectively acquired. In addition, in a case where a map image or the like is projected using the projector device 1 according to this embodiment, compared to a conventional technique, a relatively broad range of peripheral information can be projected.

### Second Embodiment

According to the projector device 1 of the first embodiment, a horizontal distortion and a vertical distortion of the projection image that occur in accordance with the projection angle θ are eliminated by the geometric distortion correction, and the amount of information is supplemented for both areas of the horizontal-direction area and the vertical-direction area. However, according to a second embodiment, a horizontal distortion is eliminated by a geometric distortion correction, and the amount of information is supplemented for the horizontal-direction area, but a distortion correction is not performed for the vertical direction.

The external view, the structure, and the functional configuration of a projector device 1 according to this embodiment are similar to those of the first embodiment.

In this embodiment, the correction control unit 108 calculates the first correction coefficient used for a horizontal distortion correction based on the projection angle θ (projection angle 123) input from the rotation control unit 104 and the view angle α (view angle 125) input from the view angle control unit 106 using Equation (11) described above and calculates the reduction rate for each line using the equation represented inside the braces { } represented in Equation (13) but does not calculate the second correction coefficient used for a vertical distortion correction.

In addition, based on the projection angle θ, the view angle α, and the first correction coefficient, the correction control unit 108 determines a cut out range from the input image data such that image data after the geometric distortion correction includes a displayable size of the display device and outputs the determined cut out range to the memory controller 107 and the extended function control unit 109.

The memory controller 107 cuts out (extracts) an image area of the cut out range determined by the correction control unit 108 from the whole area of a frame image relating to the image data stored in the image memory 101 and outputs the image area that has been cut out as image data.

In addition, the memory controller 107 performs a geometric distortion correction for the image data cut out from the image memory 101 by using the first correction coefficient and outputs the image data after the geometric distortion correction to the image processing unit 102.

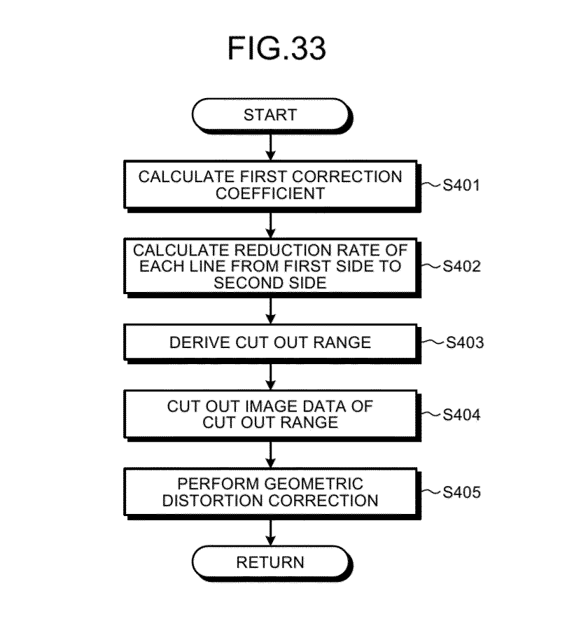

The flow of the process of projecting the image data according to the second embodiment is similar to that of the first embodiment described with reference to FIG. 31. In the second embodiment, an image data cutting out and geometric distortion correction process is different from those in step S105 illustrated in FIG. 31 of the first embodiment. FIG. 33 is a flowchart that illustrates the sequence of the image data cutting out and geometric distortion correction process according to the second embodiment.

First, in step S401, the correction control unit 108 calculates the first correction coefficient using Equation (11). In next step S402, the correction control unit 108 calculates the reduction rate of each line from the upper side (first side) to the lower side (second side) of the image data using the equation represented inside the braces { } illustrated in Equation (13).

Then, next, in step S403, the correction control unit 108 acquires a cut out range based on the first correction coefficient as described above.

Next, in step S404, the memory controller 107 cuts out image data of the cut out range from the image data stored in the image memory 101. Then, in step S405, the memory controller 107 performs the geometric distortion correction described above for the image data of the cut out range using the first correction coefficient and the reduction rate and ends the process.

Next, an example of the cutting out of image data and the geometric distortion correction performed by the geometric distortion correction unit 100 according to this embodiment will be described.

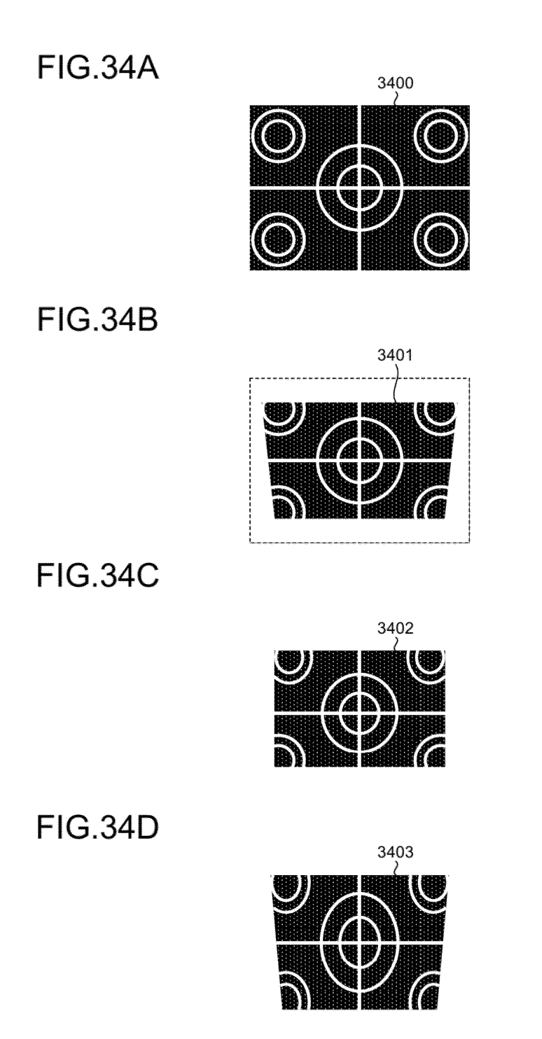

FIGS. 34A to 34D are diagrams that illustrate examples of cutting out of image data, image data on the display element 114, and a projection image in a case where the projection angle θ is greater than 0°, and the geometric distortion correction according to this embodiment is performed.

In a case where the projection angle θ is greater than 0°, as illustrated in FIG. 34A, when image data 3400 of 1920 pixels×1080 pixels is input, the memory controller 107, as illustrated in FIG. 34B, from this image data 3400, cuts out image data 3401 of a range of an area of a trapezoidal shape of a cut out range according to the projection angle θ from the image memory 101. Here, as the cut out range, by the correction control unit 108, the horizontal lower side is calculated as 1280 pixels, and the horizontal upper side is calculated as a value acquired by multiplying 1280 pixels by the reciprocal of the first correction coefficient according to the projection angle θ.

Then, the memory controller 107 performs the geometric distortion correction for the image data 3401 of the cut out range. More specifically, the memory controller 107, in the horizontal direction, corrects the image data in a trapezoidal shape according to the projection angle θ, as represented as image data 3402 in FIG. 34C. Here, as represented as image data 3401 in FIG. 34B, since the memory controller 107 cuts out pixels corresponding to the area of the trapezoidal shape according to the projection angle θ, an image of 1280 pixels×720 pixels is expanded on the display element 114, and, as represented as a projection image 3403 in FIG. 34D, the cut out area is projected without being reduced.

As above, according to this embodiment, the horizontal distortion is eliminated by the geometric distortion correction, and the amount of information is supplemented for the horizontal-direction area, but the geometric distortion correction is not performed for the vertical direction. Accordingly, not only the same advantages as those of the first embodiment are acquired, but the processing load of the correction control unit 108 can be reduced.

In the first embodiment and the second embodiment, while the method has been described in which the projection angle θ is derived by changing the projection direction of the projection unit such that the projection unit is moved while projecting the projection image onto the projection face, and a correction amount used for eliminating the geometric distortion according to the projection angle θ is calculated, a change in the projection direction does not need to be dynamic. In other words, as illustrated in FIGS. 14 and 15, the correction amount may be calculated using a fixed projection angle θ in the stopped state.

In addition, the calculation of the correction amount and the detection method are not limited to those described in this embodiment, and a cut out range including also an area other than the above-described image data area after the correction may be determined according to the correction amount.

Each of the projector devices 1 according to the first embodiment and the second embodiment has a configuration that includes hardware such as a control device such as a central processing unit (CPU), storage devices such as a read only memory (ROM) and a random access memory (RAM), an HDD, and an operation unit 14.

In addition, the rotation control unit 104, the view angle control unit 106, the image control unit 103 (and each unit thereof), the extended function control unit 109, the geometric distortion correction unit 100 (and each unit thereof), the input control unit 119, and the control unit 120 mounted as circuit units of the projector devices 1 of the first and second embodiments may be configured to be realized by software instead of being configured by hardware.

In a case where the projector device is realized by the software, an image projection program (including an image correction program) executed by the projector devices 1 according to the first and second embodiments is built in a ROM or the like in advance and is provided as a computer program product.

The image projection program executed by the projector devices 1 according to the first and second embodiments may be configured to be recorded on a computer-readable recording medium such as a CD-ROM, a flexible disk (FD), a CD-R, or a DVD so as to be provided as a file having an installable form or an executable form.

In addition, the image projection program executed by the projector devices 1 according to the first and second embodiments may be configured to be stored in a computer connected to a network such as the Internet and be provided by being downloaded through the network. In addition, the image projection program executed by the projector devices 1 according to the first and second embodiments may be configured to be provided or distributed through a network such as the Internet.

The image projection program executed by the projector devices 1 according to the first and second embodiments has a module configuration including the above-described units (the rotation control unit 104, the view angle control unit 106, the image control unit 103 (and each unit thereof), the extended function control unit 109, the geometric distortion correction unit 100 (and each unit thereof), the input control unit 119, and the control unit 120). As actual hardware, as the CPU reads the image projection program from the ROM and executes the read image projection program, the above-described units are loaded into a main memory device, the rotation control unit 104, the view angle control unit 106, the image control unit 103 (and each unit thereof), the extended function control unit 109, the geometric distortion correction unit 100 (and each unit thereof), the input control unit 119, and the control unit 120 are generated on the main storage device.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A projection device comprising:
a projection unit that converts input image data into light and projects a converted image as a projection image onto a projection face with a predetermined view angle;
a correction control unit that calculates a correction amount used for eliminating a geometric distortion occurring in the projection image according to a projection direction and determines a cut out range including also an area other than an area of the image data after the geometric distortion correction estimated according to the correction amount based on the correction amount; and
a correction unit that generates cut out image data acquired by cutting out an area of the cut out range from the input image data and performs a geometric distortion correction for the cut out image data based on the correction amount.

2. The projection device according to claim 1,
wherein the correction control unit calculates a first correction coefficient that is the correction amount of a horizontal direction of the image data based on the projection direction and the view angle and determines the cut out range based on the first correction coefficient, and
wherein the correction unit performs the geometric distortion correction based on the first correction coefficient.

3. The projection device according to claim 2,
wherein the correction control unit additionally calculates a second correction coefficient that is the correction amount of a vertical direction of the image data based on the projection direction and the view angle and determines the cut out range based on the first correction coefficient and the second correction coefficient, and
wherein the correction unit performs the geometric distortion correction based on the first correction coefficient and the second correction coefficient.

4. A projection device comprising:
a projection unit that converts input image data into light and projects a converted image as a projection image onto a projection face with a predetermined view angle;
a projection control unit that performs control changing a projection direction of the projection image based on the projection unit;
a projection angle deriving unit that derives a projection angle of the projection direction;
a correction control unit that calculates a correction amount used for correcting a geometric distortion occurring in the projection image according to the projection direction based on the projection angle and the view angle and determines a cut out range including also an area other than an area of the image data after the geometric distortion correction estimated according to the correction amount based on the correction amount; and
a correction unit that generates cut out image data acquired by cutting out an area of the cut out range from the input image data and performs a geometric distortion correction for the cut out image data based on the correction amount.

5. The projection device according to claim 4,
wherein the correction control unit calculates a first correction coefficient that is the correction amount of a horizontal direction of the image data based on the projection angle and the view angle and determines the cut out range based on the first correction coefficient, and
wherein the correction unit performs the geometric distortion correction based on the first correction coefficient.

6. The projection device according to claim 5,
wherein the correction control unit additionally calculates a second correction coefficient that is the correction amount of a vertical direction of the image data based on the projection angle and the view angle and determines the cut out range based on the first correction coefficient and the second correction coefficient, and
wherein the correction unit performs the geometric distortion correction based on the first correction coefficient and the second correction coefficient.

7. An image correction method executed by a projection device, the image correction method comprising:
converting input image data into light and projecting a converted image as a projection image onto a projection face with a predetermined view angle using a projection unit;
calculating a correction amount used for eliminating a geometric distortion occurring in the projection image according to a projection direction and determining a cut out range including also an area other than an area of the image data after the geometric distortion correction estimated according to the correction amount based on the correction amount; and
generating cut out image data acquired by cutting out an area of the cut out range from the input image data and performing a geometric distortion correction for the cut out image data based on the correction amount.

8. An image correction method executed by a projection device, the image correction method comprising:
converting input image data into light and projecting a converted image as a projection image onto a projection face with a predetermined view angle using a projection unit;
performing control changing a projection direction of the projection image using the projection unit;
deriving a projection angle of the projection direction;
calculating a correction amount used for correcting a geometric distortion occurring in the projection image according to the projection direction based on the projection angle and the view angle and determining a cut out range including also an area other than an area of the image data after the geometric distortion correction estimated according to the correction amount based on the correction amount; and
generating cut out image data acquired by cutting out an area of the cut out range from the input image data and performing a geometric distortion correction for the cut out image data based on the correction amount.

9. A computer readable recording medium that stores therein a computer program causing a computer to execute an image correction method, the method comprising:
converting input image data into light and projecting a converted image as a projection image onto a projection face with a predetermined view angle using a projection unit;
calculating a correction amount used for eliminating a geometric distortion occurring in the projection image according to a projection direction and determining a cut out range including also an area other than an area of the image data after the geometric distortion correction estimated according to the correction amount based on the correction amount; and
generating cut out image data acquired by cutting out an area of the cut out range from the input image data and performing a geometric distortion correction for the cut out image data based on the correction amount.
